(19) United States
(12) Patent Application Publication
(10) Pub. No.: US 2026/0289848 A1
(43) Pub. Date: Sep. 24, 2026

(54) SEMANTICALLY SELECTING OBJECTS IN VECTOR-BASED DESIGNS

(71) Applicant: Adobe Inc., San Jose, CA (US)

(72) Inventors: Vineet Batra, Pitam Pura (IN); Stuti Jain, Ghaziabad (IN); Nitesh Dodeja, Delhi (IN); Amit Vikram Singh, Varanasi (IN)

(21) Appl. No.: 19/086,426

(22) Filed: Mar. 21, 2025

(51) Int. Cl. G06T 11/60; G06T 7/11

(52) U.S. Cl. CPC G06T 11/60; G06T 7/11; G06T 2200/24

(57) ABSTRACT

The present disclosure relates to systems, methods, and non-transitory computer-readable media that selects a set of vector paths in a vector graphic. Furthermore, the disclosed systems access a vector graphic that includes a set of shapes. Moreover, the disclosed systems generate a semantic mask of a semantic region in response to user input indicating a portion of the vector graphic. Further, the disclosed systems select a set of vector paths in the vector graphic that corresponds to a location of the semantic mask by using a polyline model. Additionally, the disclosed systems provide the selected set of vector paths as a selection of the semantic region.

### BACKGROUND

Recent years have seen significant advancement in hardware and software platforms for creating vector graphics. Indeed, systems provide a variety of ways to manipulate vector graphics. For instance, systems can provide various selection tools to edit, resize, and apply effects to vector graphics. Despite the advances in creating vector graphics, systems suffer from a number of deficiencies with regard to accuracy and efficiency.

### SUMMARY

One or more embodiments described herein provide benefits and/or solve one or more problems in the art with systems, methods, and non-transitory computer-readable media that perform semantic selection of objects in vector graphic artwork. Specifically, the disclosed systems provide an intuitive semantic selection of objects, regardless of layer hierarchy or grouping of vector objects in a vector graphic. To illustrate, in one or more embodiments, in response to user input from a custom semantic selection tool, the disclosed systems leverage a semantic segmentation model (e.g., fine-tuned on vector data) to generate a semantic mask of a semantic region. In particular, the disclosed systems further select vector paths (e.g., objects in the vector graphic) based on the generated semantic mask. For example, the disclosed systems more accurately and efficiently select objects in the vector graphic by converting vector paths to polylines and finding vector paths that overlap with the semantic mask (e.g., vector paths that satisfy an overlap threshold). Moreover, the disclosed systems provide the set of selected vector paths as a selection of the semantic region.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a vector semantic selection system operates in accordance with one or more implementations;

FIG. 2 illustrates an overview of the vector semantic selection system generating a semantic mask and further selecting vector paths from the vector graphic corresponding to a location of the semantic mask in accordance with one or more implementations;

FIG. 3 illustrates an example diagram of the vector semantic selection system generating multiple semantic masks and corresponding prediction scores for the semantic masks in accordance with one or more implementations;

FIG. 4 illustrates an example diagram of the vector semantic selection system expanding a logical group selection based on user input in accordance with one or more implementations;

FIG. 5 illustrates an example diagram of the vector semantic selection system receiving user input as a refinement selection to refine a semantic mask in accordance with one or more implementations;

FIGS. 6A-6B illustrates an example diagram of the vector semantic selection system iterating through existing groupings of vector paths in a vector graphic to identify vector paths that satisfy an overlap threshold with a semantic mask in accordance with one or more implementations;

FIG. 7A-7B illustrates an example diagram of the vector semantic selection system identifying visible vector paths that satisfy an overlap threshold with a semantic mask in accordance with one or more implementations;

FIGS. 8A-8B illustrates an example diagram of inaccuracies and inefficiencies of existing systems selecting a vector object in a vector graphic in accordance with one or more implementations;

FIGS. 8C-8D illustrates an example diagram of the vector semantic selection system accurately and efficiently selecting a vector object and manipulating the selected vector object in accordance with one or more implementations;

FIGS. 9A-9C illustrates an example diagram of the vector semantic selection system selecting a vector object and applying a color change to the selected vector object in accordance with one or more implementations;

FIG. 10 illustrates a schematic diagram of the vector semantic selection system in accordance with one or more implementations

FIG. 11 illustrates a flowchart of a series of acts for providing a set of vector paths as a selection of a semantic region in accordance with one or more implementations;

FIG. 12 illustrates a block diagram of an exemplary computing device in accordance with one or more implementations.

### DETAILED DESCRIPTION

One or more embodiments described herein includes a vector semantic selection system that provides an intuitive semantic selection of objects in vector graphic artwork. In particular, the vector semantic selection system selects relevant vector paths in a vector graphic from context provided by user input. For example, the vector semantic selection system receives user input indicating a portion of a vector graphic (e.g., hovering over a portion of the vector graphic, a marquee selection, or a lasso tool) and utilizes the user input to generate a semantic mask of a semantic region. Moreover, the vector semantic selection system provides the semantic mask as an overlay on the vector graphic, and in some embodiments, receives user input of a selection of the semantic mask. In response, the vector semantic selection system proceeds to select vector paths in the vector graphic corresponding to a location of the semantic mask. Accordingly, the vector semantic selection system provides the set of selected vector paths as a selection of the semantic region (e.g., for manipulation by a user of a computing device).

As mentioned above, in some embodiments, the vector semantic selection system receives user input selecting the provided semantic mask, and the vector semantic selection system proceeds to select the relevant vector paths. In particular, the vector semantic selection system converts the vector graphic and the semantic mask (e.g., a defined region of interest) to polylines and determines which polylines in the vector graphic overlap with the semantic mask (e.g., satisfy an overlap threshold). In some embodiments, the vector semantic selection system iterates through existing groupings of vector paths in the vector graphic to find a group that best satisfies an overlap threshold with the semantic mask. In some embodiments, if the vector semantic selection system determines that there is not an existing grouping of vector paths that satisfies an overlap threshold, the vector semantic selection system proceeds to select vector paths based on user visible paths.

In one or more embodiments, the vector semantic selection system predicts multiple masks in response to user input. In particular, as mentioned above, the vector semantic selection system receives user input indicating a region, such as a user hovering over a point in a vector graphic. Moreover, the vector semantic selection system processes the user input (e.g., the indicated point) along with a rasterized version of the vector graphic to generate multiple semantic masks and corresponding prediction scores. For example, the vector semantic selection system generates semantic masks based on the user input and the corresponding prediction scores indicate how strongly the semantic masks align with a semantic region of the user input. Accordingly, the vector semantic selection system selects a semantic mask from the set of semantic masks with the highest prediction score and provides the selected semantic mask overlayed on the vector graphic.

In one or more embodiments, the vector semantic selection system further provides an option for user input refining a semantic mask. In particular, the vector semantic selection system receives user input either expanding a semantic region in the vector graphic or reducing a semantic region in the vector graphic. In other words, the vector semantic selection system allows for precise control over the selection of vector paths in a vector graphic. In some embodiments, in response to receiving user input either expanding or reducing the semantic region, the vector semantic selection system proceeds to select the relevant vector paths for the expanded or reduced semantic region.

As mentioned above, existing systems suffer from a number of issues relating to computational accuracy and efficiency. For example, existing systems provide a variety of tools to edit, color, resize, and apply effects to a vector graphic. In particular, existing systems provide various selection tools such as a group selection tool, a lasso tool, and magic wand tool, however these tools fall short in offering an intuitive and efficient selection process of specific elements in a vector graphic. In some embodiments, existing systems require numerous clicks, drags, and keyboard shortcuts to attempt to select an element within a vector graphic. As such, despite existing systems providing selection tools, the selection process of elements in a vector graphic are extremely tedious and error prone. In other words, existing systems provide tools that inaccurately select elements in a vector graphic.

Relatedly, vector graphics are typically organized in a complex manner and include unintuitive groupings of elements, absence of visual indicators and complicated layer hierarchies that hinder logical object selection within a vector graphic. For example, when selecting an object in a vector graphic composed of multiple shapes across various layers, the lack of logical grouping makes precise selection particularly time consuming. Accordingly, existing systems struggle with accurately selecting specific elements within a vector graphic.

As mentioned above, existing systems suffer from various computational inefficiencies. Specifically, existing systems typically require numerous clicks, drags, and keyboard shortcuts to attempt to select an element within the vector graphic. As such, existing systems inefficiently require excessive user input to home in on a desired element within a vector graphic. Accordingly, in digital design document workflows involving vector graphics, existing systems consume excess resources and time to edit vector graphics.

In one or more embodiments, the vector semantic selection system provides several improvements over existing systems in relation to accuracy and efficiency. As mentioned above, existing systems fall short in offering an intuitive and efficient selection process of specific elements in a vector graphic. In contrast, the vector semantic selection system generates a semantic mask in response to user input indicating a portion in a vector graphic and further selects vector paths in the vector graphic corresponding to a location of the semantic mask. As a result, rather than requiring numerous clicks, drags, and keyboard shortcuts to attempt to select an element within a vector graphic, the vector semantic selection system accurately selects relevant vector paths in a vector graphic based on user input.

As also mentioned above, vector graphics are typically organized in a complex manner and include unintuitive groupings of elements, absence of visual indicators and complicated layer hierarchies that hinder logical object selection within the vector graphic. Despite this, the vector semantic selection system accurately selects vector paths in a vector graphic based on a semantic mask of a semantic region that is generated from user input indicating a portion within the vector graphic. In particular, the vector semantic selection system converts a vector graphic to polylines, converts a semantic mask to polylines, and determines vector paths in the vector graphic that overlap with the semantic mask (e.g., that satisfy an overlap threshold). In other words, despite vector paths being organized in a complex manner and complicated layer hierarchies, the vector semantic selection system accurately identifies relevant vector paths that conform with user input indicating a portion of the vector graphic. Moreover, the vector semantic selection system provides the set of vector paths as a selection of the semantic region.

Relatedly, the vector semantic selection system improves computational efficiency relative to existing systems. As mentioned above, vector graphics are composed of multiple shapes across various layers and lack logical groupings which makes precise selection particularly time consuming. To rectify this, the vector semantic selection system generates a semantic mask of a semantic region based on user input and further utilizes the semantic mask to select relevant vector paths. As such, the vector semantic selection system reduces the time and resources needed to select specific elements in a vector graphic. In other words, the vector semantic selection system streamlines the tedious and error prone process of selecting elements in a vector graphic by selecting relevant vector paths corresponding to a location of the semantic mask and providing the selected vector paths as a selection of the semantic region.

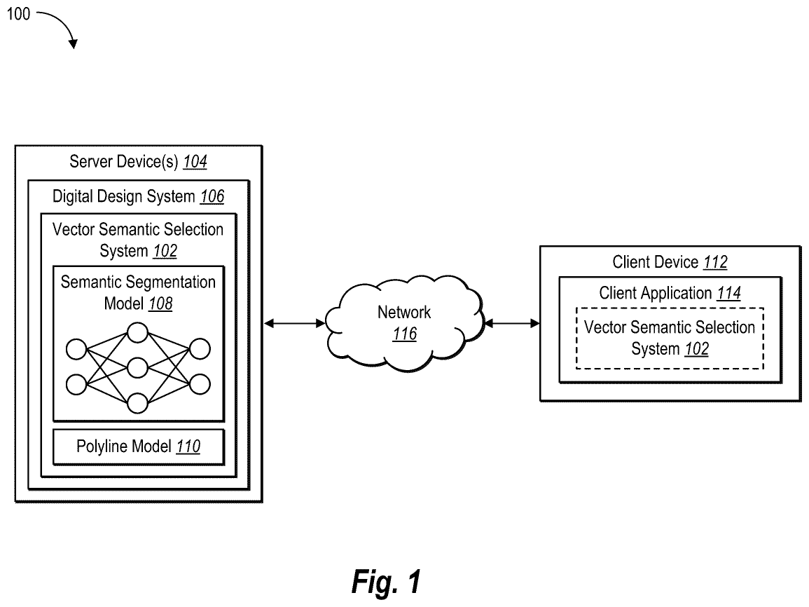

Additional details regarding the vector semantic selection system will now be provided with reference to the figures. For example, FIG. 1 illustrates a schematic diagram of an exemplary system environment 100 in which a vector semantic selection system 102 operates. As illustrated in FIG. 1, the system environment 100 includes server device(s) 104, a digital design system 106, a network 116, and a client device 112. Additionally, FIG. 1 illustrates that the digital design system 106 includes the vector semantic selection system 102, which includes a semantic segmentation model 108 and a polyline model 110. Moreover, the client device 112 includes a client application 114 (e.g., a client side digital design editing application).

Although the system environment 100 of FIG. 1 is depicted as having a particular number of components, the system environment 100 is capable of having a different number of additional or alternative components (e.g., a different number of server devices, client devices, or other components in communication with the vector semantic selection system 102 via the network 116). Similarly, although FIG. 1 illustrates a particular arrangement of the server device(s) 104, the network 116, and the client device 112, various additional arrangements are possible.

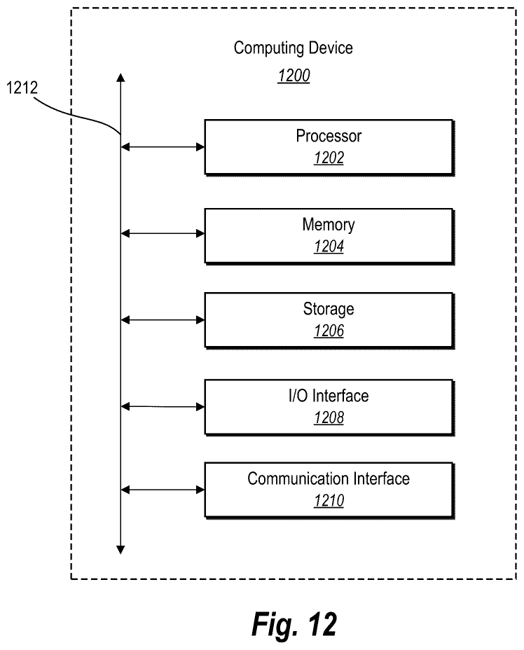

The server device(s) 104 and the client device 112 are communicatively coupled with each other either directly or indirectly (e.g., through the network 116 discussed in greater detail below in relation to FIG. 12). Moreover, the server device(s) 104 and the client device 112 include one or more of a variety of computing devices (including one or more computing devices as discussed in greater detail in relation to FIG. 12).

As mentioned above, the system environment 100 includes the server device(s) 104. In one or more embodiments, the server device(s) 104 process user input indicating a portion in a vector graphic for selecting a specific element in the vector (e.g., by employing the semantic segmentation model 108 and/or the polyline model 110). In one or more embodiments, the server device(s) 104 comprise a data server. In some implementations, the server device(s) 104 comprise a communication server or a web-hosting server.

In some embodiments, the client device 112 is associated with the one or more user accounts that edit vector graphics within a digital design document by selecting vector objects in a vector graphic. In one or more embodiments, the client device 112 includes smartphones, tablets, desktop computers, laptop computers, head-mounted-display devices, or other electronic devices. The client device 112 includes one or more software applications (e.g., the client application 114) for modifying vector graphics in accordance with the digital design system 106. In one or more embodiments, the client application 114 includes a software application hosted on the server device(s) 104 accessible by the client device 112 through another application, such as a web browser.

To provide an example implementation, in some embodiments, the digital design system 106 on the server device(s) 104 supports the client application 114 on the client device 112. For instance, in some cases, the vector semantic selection system 102 on the server device(s) 104 fine-tunes the semantic segmentation model 108 with vector-based data. In response, the vector semantic selection system 102, via the server device(s) 104, provides the fine-tuned semantic segmentation model 108 and the polyline model 110 to the client device 112. In other words, the client device 112 obtains (e.g., downloads) the semantic segmentation model 108 and the polyline model 110 from the server device(s) 104 that is already fine-tuned/optimized. Once downloaded, the semantic segmentation model 108 and the polyline model 110 on the client device 112 is able to select a set of vector paths in a vector graphic corresponding to a location of a semantic mask independent from the server device(s) 104. In one or more alternative implementations, the vector semantic selection system 102 generates or learns parameters for the semantic segmentation model 108 in whole or in part on the client device 112.

In alternative implementations, the digital design system 106 includes a web hosting application that allows the client device 112 to interact with content and services hosted on the server device(s) 104. To illustrate, in one or more implementations, the client device 112 accesses a software application supported by the server device(s) 104. In response, the digital design system 106 on the server device(s) 104 provides tools for performing vector graphic editing. In other words, the client device 112 does not have to download the vector semantic selection system 102, the semantic segmentation model 108 or the polyline model 110 while still being able to access/utilize the fine-tuned/optimized tools provided by the digital design system 106 via a web hosting application.

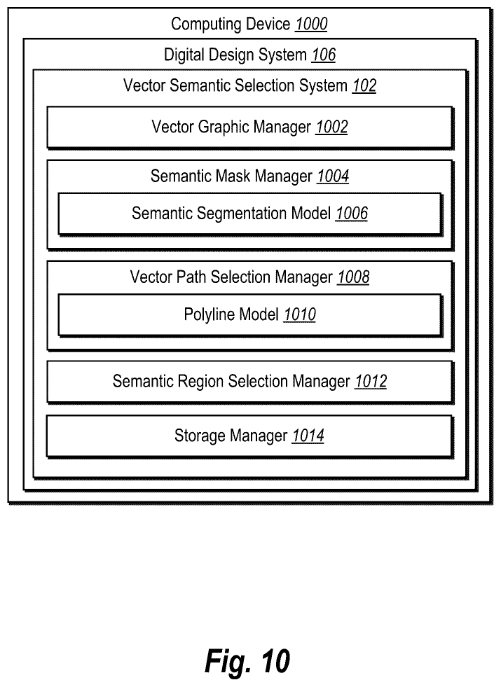

In some embodiments, the vector semantic selection system 102 is implemented in whole, or in part, by the individual elements of the system environment 100. For instance, although FIG. 1 illustrates the vector semantic selection system 102 implemented or hosted on the server device(s) 104, different components of the vector semantic selection system 102 are able to be implemented by a variety of devices within the system environment 100. For example, one or more (or all) components of the vector semantic selection system 102 are implemented by a different computing device or a separate server from the server device(s) 104. Indeed, as shown in FIG. 1, the client device 112 includes the vector semantic selection system 102. Example components of the vector semantic selection system 102 will be described below with regard to FIG. 10.

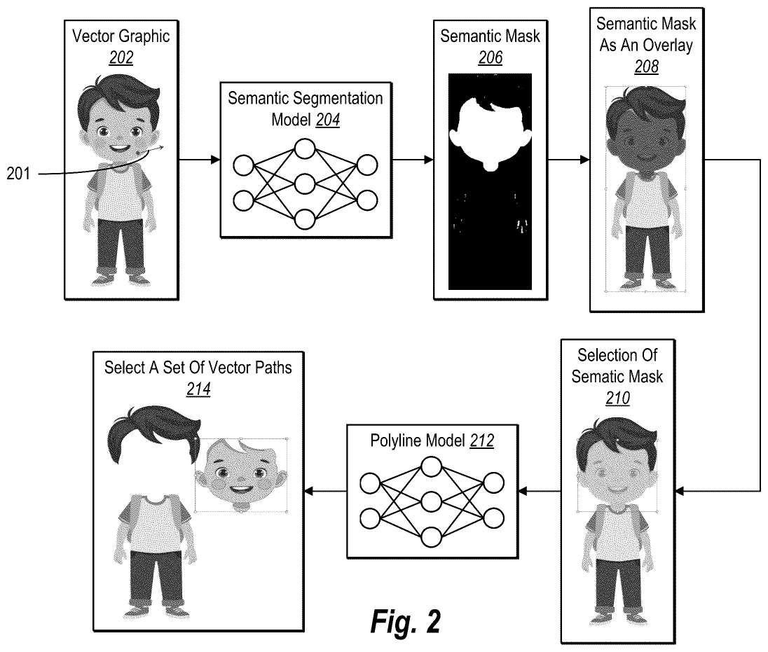

As mentioned above, in certain embodiments, the vector semantic selection system 102 generates a semantic mask in response to user input. FIG. 2 illustrates the vector semantic selection system 102 generating a semantic mask and further selecting vector paths in the vector graphic corresponding to a location of the semantic mask in accordance with one or more embodiments. In particular, FIG. 2 shows a vector graphic 202 and the vector semantic selection system 102 receiving user input 201 indicating a portion of the vector graphic 202.

In one or more embodiments, the vector graphic 202 refers to a digital image that includes various mathematical equations to define shapes, lines, curves, and colors. In particular, the vector graphic 202 differs from raster graphics in that the vector graphic 202 is based on geometry such as points, paths, and polygons. In contrast with raster graphics, the vector graphic 202 is scalable and does not lose quality or become pixelated. In some embodiments, the vector graphic 202 includes one or more shapes filled with color functions that define how color varies across the vector graphic 202. To illustrate, FIG. 2 shows the vector graphic 202 as a boy (e.g., a human object) that further includes various shapes, lines, and curves defining elements such as the hands, arms, legs, face, and head.

In one or more embodiments, the vector semantic selection system 102 provides the vector graphic 202 to a computing device via a digital design document of a digital design application. In some embodiments, a digital design document refers to a file with various design properties. In particular, the digital design document includes digital design elements that fit within a dimension of the digital design document. In some embodiments, the digital design document includes vector graphics such as digital invitations, digital cards, digital fliers, digital posters, and various other digital files that include design elements such as text, images, and other artistic elements.

In one or more embodiments, a layered digital design document refers to a document or file that is created to include design vector-based graphics (e.g., scalable shapes and paths that allows for high-resolution output at any size), illustrations, logos, and additional artwork/text elements. Specifically, the vector semantic selection system 102 allows a user of a computing device to manipulate/edit design elements within a digital design document via a digital design application.

In some embodiments, the vector semantic selection system 102 allows for the selection of vector paths within a vector graphic based on a semantic meaning/context provided by a user of a computing device (e.g., the user input 201 indicates a point on the face of the boy). In particular, despite vector objects being distributed across different layers in a digital design document, the vector semantic selection system 102 is still able to accurately select vector paths that conform with user provided semantic meaning/context (e.g., the face of the boy). In one or more embodiments, a layer of a layered digital design document refers to different parts of a digital design, such as a background layer, and an object layer.

In one or more embodiments, a digital design application refers to a software application for creating and editing digital design documents (e.g., vector-based artwork). Specifically, the vector semantic selection system 102 provides a digital design application for a user of a computing device to create graphics, illustrations, and digital visual content, and to further edit digital design documents. For instance, the vector semantic selection system 102 provides a digital design application with various drawing and illustration tools to create/manipulate shapes, paths, freehand draw, move objects (e.g., text or visual objects), adjust the size of objects, edit text object elements, change background elements, change color attributes, font attributes, color gradients, and layering/organization of the digital design document.

As shown in FIG. 2, the vector semantic selection system 102 utilizes a semantic segmentation model 204 to generate a semantic mask 206 from the vector graphic 202. In one or more embodiments, the semantic segmentation model 204 refers to a computer vision machine learning model (e.g., fine-tuned on vector data) used for generating the semantic mask 206. Specifically, the vector semantic selection system 102 utilizes the semantic segmentation model 204 to generate the semantic mask 206 from the user input 201 (e.g., an indication of a portion of the vector graphic 202, the face of the boy). For instance, the vector semantic selection system 102 utilizes the semantic segmentation model to process the user input 201 and a rasterized version of the vector graphic 202 to generate the semantic mask 206. In particular, the vector semantic selection system 102 converts the vector graphic 202 into the rasterized version and passes the rasterized version of the vector graphic 202 to the semantic segmentation model 204.

As shown, the vector semantic selection system 102 generates the semantic mask 206 from the user input 201. In one or more embodiments, the semantic mask 206 refers to a mask used to define and separate a region within the vector graphic 202 based on the user input 201. In other words, the vector semantic selection system 102 generates the semantic mask 206 of a semantic region based on a type of vector object or region the user input 201 represents. In particular, the vector semantic selection system 102 receives context (e.g., the user input 201 hovering of a face of the boy depicted in FIG. 2) for a selection and generates the semantic mask 206 for the indicated context (e.g., the semantic mask 206 covers the face of the human object in the vector graphic 202).

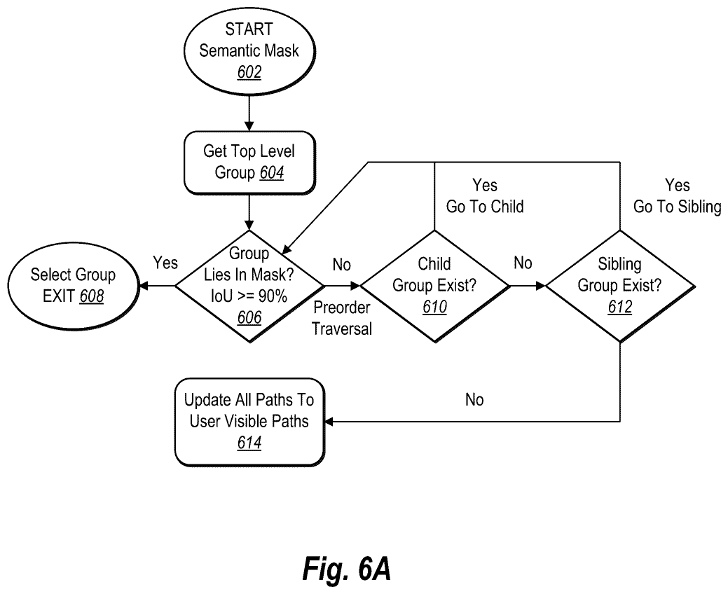

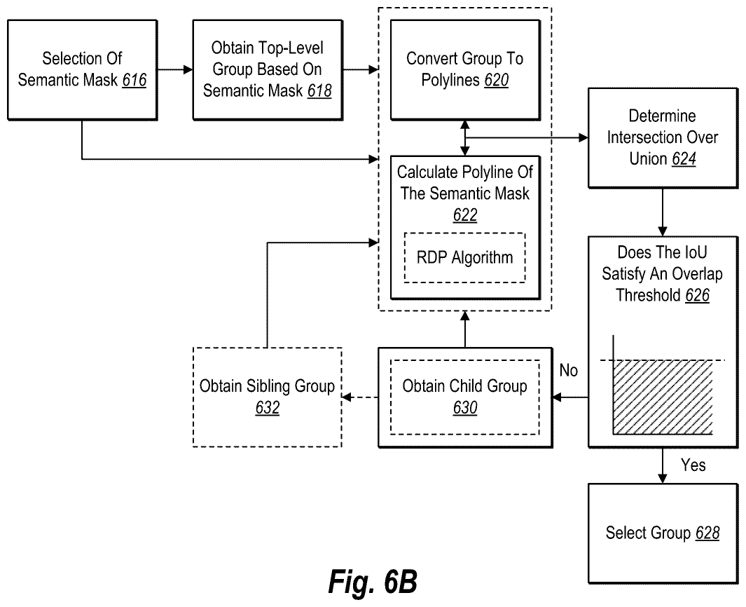

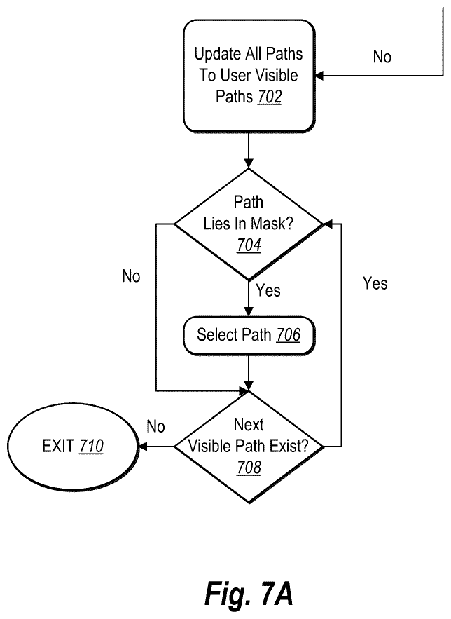

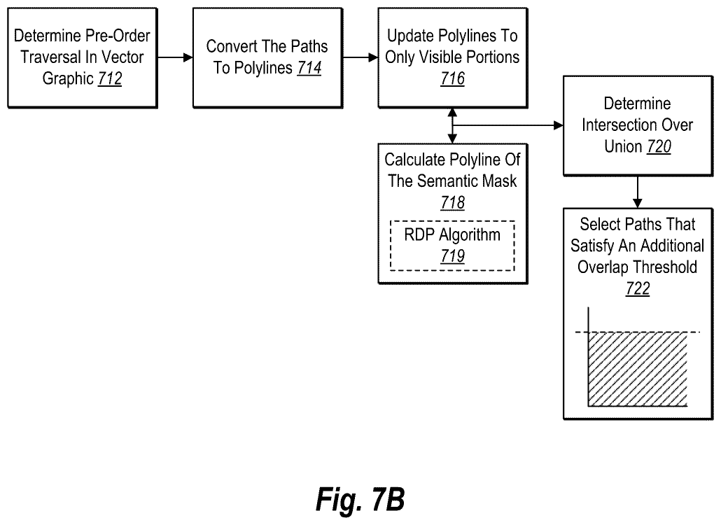

Moreover, FIG. 2 shows the vector semantic selection system 102 providing the semantic mask as an overlay 208 on the vector graphic 202 via the digital design document of the digital design application. Further, FIG. 2 shows the vector semantic selection system 102 receiving a selection 210 of the semantic mask (e.g., a user of a computing device confirms that the semantic mask 206 correctly covers a portion of the vector graphic 202). As shown, in response to the selection 210, the vector semantic selection system 102 utilizes a polyline model 212 (e.g., additional details of the polyline model 212 are given below in FIGS. 6A-7B) to select a set of vector paths 214 that correspond to a location of the semantic mask 206. In other words, the vector semantic selection system 102 selects the set of vector paths 214 that are in a region of the vector graphic 202 covered by the semantic mask 206.

In one or more embodiments, a vector path refers to a sequence of anchor points and control points that form a line or curve. In particular, a vector path is a straight or curved line that is used to define the shape of objects. In some embodiments, an anchor point of a vector path defines points that mark the beginning and end of a vector path, and in some instances an intermediate point of a vector path. In some embodiments, a control point of a vector path defines the direction and shape of the curve. In particular, a control point allows for the creation of smooth and continuous curves, rather than sharp angles. Thus, a vector graphic typically contains a plurality of vector paths (e.g., with a plurality of anchor points and control points) that make up vector objects.

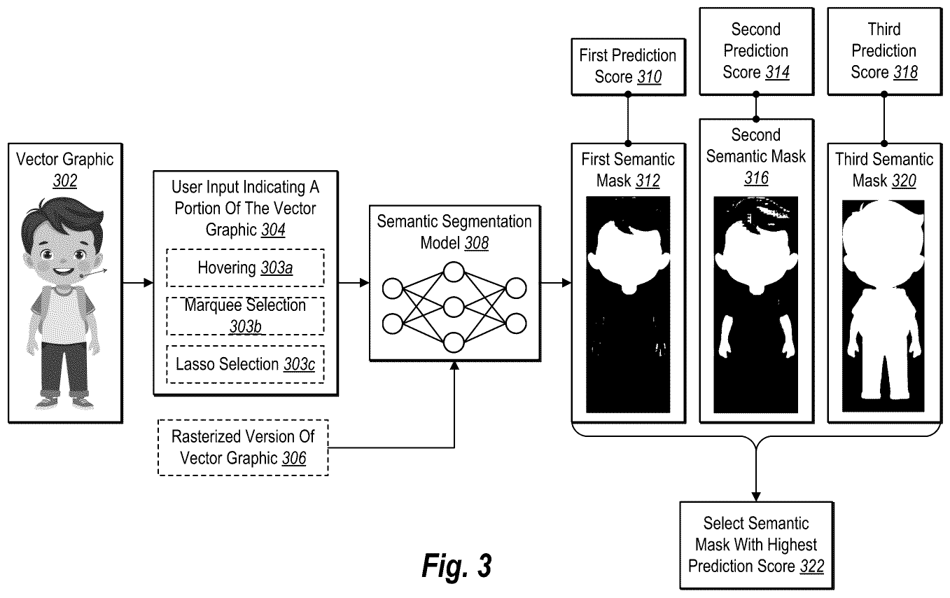

As mentioned above, in some embodiments, the vector semantic selection system 102 generates multiple semantic masks with corresponding prediction scores. FIG. 3 illustrates the vector semantic selection system 102 generating three semantic masks in response to user input and selecting one of the three semantic masks in accordance with one or more embodiments.

As shown in FIG. 3, the vector semantic selection system 102 accesses a vector graphic 302. In one or more embodiments, the vector graphic 302 includes one or more vector objects. For example, a vector object includes an element within a vector graphic that is represented by mathematical equations. In particular, a vector object includes paths (e.g., lines or curves), shapes, text objects, a group (e.g., a collection of vector paths treated as a single unit), and a vector image (e.g., a scalable vector graphic) embedded within the vector graphic. In other words, a vector object is made up of one or more vector paths.

To illustrate, a vector object depicts a person, place, text, or thing in a vector graphic. In some embodiments, a vector object includes a person, an item, a natural object (e.g., a tree or rock formation) or a structure depicted in a vector graphic. Moreover, in some embodiments, a vector object includes text that depicts a word or a series of words. In some embodiments, a vector object refers to a plurality of elements that, collectively, are distinguished from other elements depicted in a vector graphic. In some embodiments, a vector object includes a collection of buildings that make up a skyline. In some embodiments, a vector object more broadly includes a (portion of a) foreground or other element(s) depicted in a vector graphic as distinguished from a background.

In one or more embodiments, a shape of a set of shapes refers to a geometric form within the vector graphic 302 that is defined by one or more vector paths. In particular, a shape includes lines, a polygon, a circle, and curves. For instance, the shape includes closed shapes that connect back to a starting point or open shapes that do not connect back to a starting point (e.g., an open vector path or line). In some embodiments, the term vector object is used interchangeably with a shape. To illustrate, the vector graphic 302 depicts a human boy which the entire human boy is a vector object as well as a shape (e.g., a human shape made up of various vector paths). Moreover, individual elements of the human boy (e.g., the arms, legs, feet, hands, face, hair, head) are considered shapes or vector objects in the vector graphic 302.

In one or more embodiments, the vector graphic 302 includes one or more groupings of vector paths. In particular, a grouping of vector paths refers to one or more vector objects treated as a single unit. For instance, the grouping of vector paths refers to a collection of shapes, paths, and/or text within a vector graphic. Moreover, the vector graphic 302 contains groupings of vector paths which simplifies the manipulation of multiple elements. Specifically, a grouping of vector paths within the vector graphic 302 allows a user of a computing device to resize, select, and/or manipulate the collection of shapes, paths, and/or text as a single unit (e.g., manipulate vector objects/shapes). Thus, in some embodiments, a grouping of vectors paths of a vector graphic refers to a single vector object or multiple vector objects.

In one or more embodiments, a nested grouping of vector paths refers to a group of one or more vector objects contained within another group. In particular, a nested grouping refers to a sub-grouping of vector paths that is encompassed by a parent grouping of vector paths. To illustrate, in some embodiments, a grouping (e.g., a parent group) includes a foreground of two human vector objects and a tree vector object. Moreover, the grouping (e.g., the parent group) includes multiple nested groupings such as a first human vector object grouping of vector paths, a second human vector object grouping, and a tree vector object grouping. Additionally, in some embodiments, each of the nested groupings further contain additional nested groupings. In particular, the first human vector object grouping contains an upper body vector object grouping or a head vector object grouping.

FIG. 3 shows the vector graphic 302 that portrays the human boy. To illustrate, the vector graphic 302 contains a top-level grouping (e.g., parent grouping) of vector paths for the entire human boy, a first nested grouping of vector paths for the head and torso of the human boy, a second nested grouping of vector paths for the head, and a third nested grouping of vector paths for the face. Moreover, the vector graphic 302 further includes another nested grouping of vector paths for the legs (e.g., the another nested grouping is a sibling grouping relative to the first nested grouping as it is not encompassed by the first nested grouping) and a nested grouping of vector paths for the torso (e.g., the nested grouping for the torso is a sibling grouping relative to the second nested grouping).

Furthermore, FIG. 3 shows the vector semantic selection system 102 receiving user input 304 indicating a portion of the vector graphic 302. In particular, the user input 304 indicating a portion of the vector graphic 302 includes hovering 303a, a marquee selection 303b, and a lasso selection 303c. In one or more embodiments, the hovering 303a refers to user input indicating (e.g., with a mouse or with a pointer) a specific location in the vector graphic 302 as a semantic region (e.g., a region of interest). In particular, the hovering 303a includes a pointer moving over a specific point in the vector graphic 302 and in some embodiments, does not include an actual selection (e.g., click) by a user for that specific point. In some embodiments, the hovering 303a includes an actual selection (e.g., click) by a user of a computing device). In response to the hovering 303a, the vector semantic selection system 102 utilizes the specific point in the vector graphic 302 as context for the semantic region.

In one or more embodiments, the marquee selection 303b refers to a graphical selection technique to define a specific area of interest within the vector graphic 302. In particular, the marquee selection 303b includes a dashed or dotted rectangular or elliptical outline that visually indicates a selected region in the vector graphic 302. For instance, the vector semantic selection system 102 provides the marquee selection 303b as a selection tool to form a box or shape around content in the vector graphic 302.

In one or more embodiments, the lasso selection 303c refers to a graphical selection tool that allows a user of a computing device to manually define a freeform selection area. In particular, the vector semantic selection system 102 provides the lasso selection 303c as a tool for a user of a computing device to draw an outline around a desired region in the vector graphic 302. In contrast to the marquee selection 303b, in some embodiments, the lasso selection 303c follows an irregular path or shape in the vector graphic 302.

Furthermore, as shown in FIG. 3, in some embodiments, the vector semantic selection system 102 generates a rasterized version 306 of the vector graphic 302. As mentioned above, the vector semantic selection system 102 generates the rasterized version 306 of the vector graphic 302 to further generate a semantic mask. In one or more embodiments, a rasterized version of a digital image refers to an image with various pictorial elements. In particular, the pictorial elements include pixel values that define the spatial and visual aspects of the digital image such as text and image objects. In some embodiments, a rasterized version of a digital image refers to an image which includes a grid of pixels. In particular, the rasterized version of the digital image includes a fixed resolution as determined by a number of pixels within the image.

As shown in FIG. 3, the vector semantic selection system 102 utilizes a semantic segmentation model 308 to generate semantic masks from the rasterized version 306 of the vector graphic 302 and the user input 304 indicating a portion of the vector graphic. In some embodiments, the vector semantic selection system 102 generates a prompt for the semantic segmentation model 308, where the prompt includes the user input 304 and the rasterized version 306 of the vector graphic 302. In particular, FIG. 3 shows the vector semantic selection system 102 generating a first semantic mask 312 with a first prediction score 310, a second semantic mask 316 with a second prediction score 314, and a third semantic mask 320 with a third prediction score 318.

In one or more embodiments, the vector semantic selection system 102 generates a semantic mask of a semantic region which defines a region of interest in the vector graphic 302. In particular, the semantic mask defines the region of interest for the vector semantic selection system 102 to determine a relevant set of vector paths in the vector graphic 302 that overlap with the semantic mask (e.g., that satisfies an overlap threshold).

In one or more embodiments, the vector semantic selection system 102 generates a prediction score along with a semantic mask. In particular, a prediction score refers to a numerical value or metric that indicates confidence or accuracy of a semantic mask covering a semantic region as indicated by the user input 304. For example, the vector semantic selection system 102 generates prediction scores that indicate a level of confidence for each semantic mask accurately encompassing a semantic region based on the user input 304.

To illustrate, the vector semantic selection system 102 generates a prediction score that indicates a probability of a specific element belonging to a semantic group (e.g., the semantic group indicated by the user input). In other words, if the user of the computing device hovers over the face of a human vector object, the vector semantic selection system 102 generates the first semantic mask 312 encompassing the face, the second semantic mask 316 encompassing the face and the hair, and the third semantic mask 320 encompassing the entire body. Moreover, because the user input 304 was a user hovering over the face of the human vector object, the vector semantic selection system 102 generates the first prediction score 310 for the first semantic mask 312 that is higher than the second prediction score 314 and the third prediction score 318.

Additionally, FIG. 3 shows the vector semantic selection system 102 performing an act 322 of selecting a semantic mask with the highest prediction score. As mentioned above, the vector semantic selection system 102 generates the prediction scores based on the user input 304, thus in some embodiments, the vector semantic selection system 102 selects the first semantic mask 312 to provide to a user of a computing device.

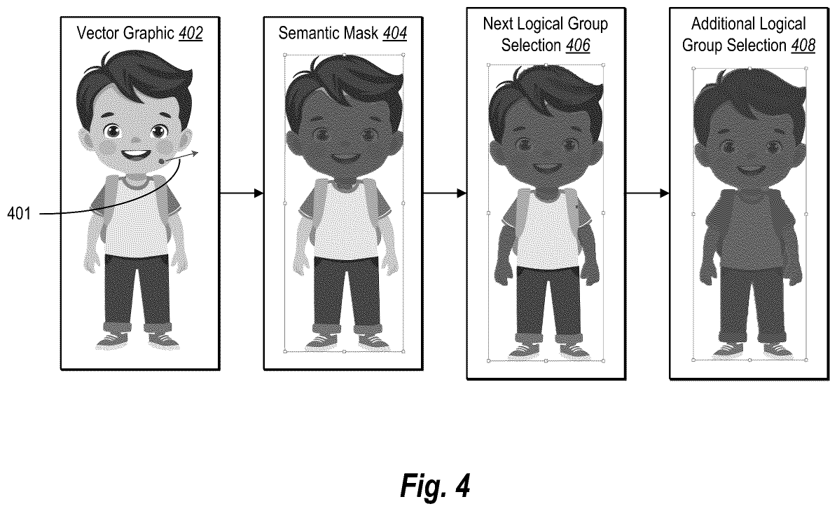

As mentioned above, the vector semantic selection system 102 provides tools for a user to modify a semantic mask. FIG. 4 illustrates the vector semantic selection system 102 expanding a logical group selection of a semantic mask in a vector graphic. For example, FIG. 4 shows the vector semantic selection system 102 receiving user input 401 that indicates a portion of a vector graphic 402. Further, FIG. 4 shows that in response to the user input 401, the vector semantic selection system 102 generates a semantic mask 404 (e.g., an initial semantic mask) that covers a face vector object/shape in the vector graphic 402.

Moreover, FIG. 4 shows the vector semantic selection system 102 receiving additional user input (e.g., a user pressing an up-arrow key) and the vector semantic selection system 102 modifying the semantic mask 404 to include a next logical group selection 406. In particular, the next logical group selection 406 covers the face and the upper body (e.g., the torso) of the human boy.

Furthermore, FIG. 4 shows the vector semantic selection system 102 receiving user input (e.g., a user again pressing an up-arrow key) and the vector semantic selection system 102 again modifies the semantic mask 404 to further include an additional logical group selection 408. In particular, the additional logical group selection 408 covers the entire human boy.

In one or more embodiments, the vector semantic selection system 102 smoothly modifies the semantic mask 404 within the vector graphic 402 because the semantic masks are pre-sorted based on prediction score and area. In other words, as discussed above in FIG. 3, the vector semantic selection system 102 generates multiple semantic masks where each of the multiple semantic masks are pre-sorted based on the generated prediction score and the area it covers in the vector graphic 402 (e.g., the smaller the area the more precise). In particular, when the vector semantic selection system 102 receives user input (e.g., the up-arrow key), the next semantic mask in a sorted list is selected to encompass a larger area (e.g., effectively transitioning to the next logical element within the parent artwork).

Although not shown in FIG. 4, in some embodiments, the vector semantic selection system 102 initially receives input expanding the area covered by the semantic mask (e.g., a user presses the up-arrow key) in the vector graphic 402 and then receives user input reducing the area covered by the semantic mask (e.g., a user presses the down-arrow key). Furthermore, in some embodiments, the vector semantic selection system 102 receives a selection of a semantic mask encompassing at least a portion of the vector graphic 402, and the vector semantic selection system 102 selects vector paths corresponding to a location of the semantic mask.

Moreover, in one or more embodiments, the vector semantic selection system 102 trains/fine-tune a semantic segmentation model discussed above using vector-data. In particular, the vector semantic selection system 102 fine-tunes the semantic segmentation model to generate a semantic mask for a semantic region based on user input. For example, the vector semantic selection system 102 leverages training data that includes vector graphics, data points (e.g., user inputs), and rasterized versions of vector graphics to fine-tune the semantic segmentation model.

In some embodiments, the vector semantic selection system 102 utilizes a semantic segmentation model to generate a semantic mask prediction from a vector graphic, a data point, and a corresponding rasterized version of the vector graphic. In particular, the vector semantic selection system 102 compares the semantic mask prediction with a ground truth classifier of a semantic region indicated by the data point (e.g., the user input data point is classified as indicating a face region, an arm region, a hair region, etc.).

Moreover, in some embodiments, the vector semantic selection system 102 modifies parameters of a semantic segmentation model based on the comparison of the semantic mask prediction with the ground truth classifier of the semantic region. In particular, if the ground truth classifier indicates a face region, but the semantic mask prediction covers the face and the hair, then the vector semantic selection system 102 provides negative feedback to the semantic segmentation model. In some embodiments, the vector semantic selection system 102 generates a measure of loss from the comparison and modifies parameters of the semantic segmentation model to minimize a distance between the prediction and the ground truth classifier.

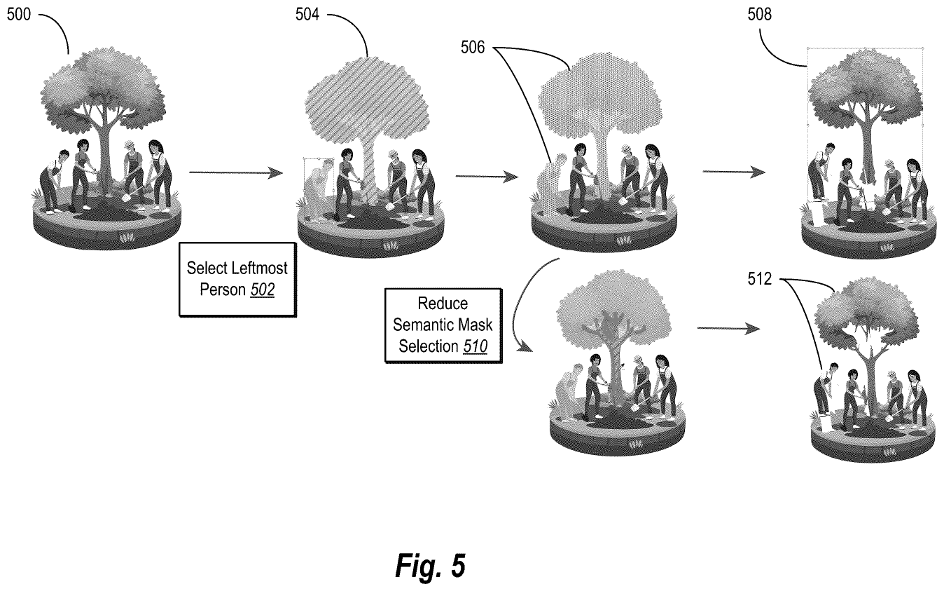

As mentioned above, the vector semantic selection system 102 provides tools for a user refining a semantic mask. FIG. 5 illustrates the vector semantic selection system 102 receiving refinement selections to refine a semantic mask in a vector graphic in accordance with one or more embodiments. In one or more embodiments, a refinement selection refers to an additional input from a user of computing device (e.g., in addition to the initial indication) to indicate a desire to expand a semantic region of the semantic mask or to reduce a semantic region of the semantic mask.

FIG. 5 shows a vector graphic 500 and also shows the vector semantic selection system 102 receiving user input 502. In particular the user input 502 includes a selection of a leftmost person in the vector graphic and further includes a modifier 504 to expand a semantic region of the semantic mask initially encompassing the leftmost person. For example, the modifier 504 (e.g., user input such as a user clicking the shift key) adds the tree shown in the vector graphic 500 to be part of the semantic mask of the semantic region. Specifically, FIG. 5 shows a bounding box around the leftmost person and the modifier as a striped pattern across the tree, which indicates that the tree was added after the initial selection of the leftmost person.

Furthermore, FIG. 5 shows a selection 506 of the leftmost person and the tree with the same pattern. In particular, the selection 506 indicates that the leftmost person and the tree are ready for manipulation. For example, FIG. 5 shows manipulation 508 that encompasses both the leftmost person and the tree being moved to a higher portion of the vector graphic 500.

FIG. 5 shows that in some embodiments, the vector semantic selection system 102 receives user input 510 to reduce a semantic mask selection of a semantic region. In particular, FIG. 5 shows the vector semantic selection system 102 receiving the user input 510 to not include a trunk of the tree. As shown in FIG. 5, the trunk of the tree has a different pattern (stripped) than the branches and the leftmost person. Moreover, FIG. 5 shows that in response to a selection of the reduced semantic mask selection of the semantic region, the vector semantic selection system 102 allows for manipulation of the reduced semantic mask selection. In particular, FIG. 5 shows a manipulation 512 that moves the top of the tree and the leftmost person to a higher portion of the vector graphic 500.

FIG. 5 shows both an “addition mode” and a “subtraction mode” of the semantic region. In particular, as described above, the addition mode includes expanding a portion of vector artwork currently under a cursor. In other words, an initial selection is for the leftmost person and the vector semantic selection system 102 further receives a bitwise OR operation between the current selection and another hovered area in the vector graphic (e.g., the tree).

Moreover, as described above, the subtraction mode includes reduces a portion of the vector artwork currently under a cursor. In other words, a user of a computing device removes a hovered portion from the current selection. In particular, the vector semantic selection system 102 first inverts the hovered area (e.g., modifies selected elements in the vector graphic to unselected elements) and then performs a bitwise AND operation between the current selection and the inverted hovered area (e.g., eliminating the hovered portion from the current selection).

As mentioned above, the vector semantic selection system 102 converts the vector graphic to polylines using a polyline model to subsequently select a set of vector paths. FIGS. 6A-6B illustrates the vector semantic selection system 102 iterating through existing groupings of vector paths in the vector graphic to identify vector paths that satisfy an overlap threshold with a semantic mask in accordance with one or more embodiments.

As shown in FIG. 6A, the vector semantic selection system 102 performs an act 602 of generating a semantic mask (e.g., based on user input), and then performing an act 604 of obtaining a top-level grouping of vector paths from the vector graphic. In particular, as mentioned above, in some embodiments, a vector graphic is arranged in multiple groups such as a human object grouping, an upper body grouping, a lower body grouping, a face grouping, a hair grouping, etc. To illustrate, in some embodiments, the act 604 of obtaining the top-level group includes obtaining the human object grouping of vector paths.

Furthermore, FIG. 6A shows the vector semantic selection system 102 performing an act 606 of determining whether a group (e.g., the top-level group) lies in the semantic mask within an overlap threshold. In particular, the vector semantic selection system 102 determines an intersection over union of the group (e.g., the top-level group) with the semantic mask. Moreover, FIG. 6A shows that if the top-level group does lie in the mask within the overlap threshold, the vector semantic selection system 102 performs an act 608 of selecting the group and exiting. In other words, the vector semantic selection system 102 selects the set of vector paths for the top-level group as a selection of a semantic region.

Furthermore, FIG. 6A shows that if the top-level group does not lie in the mask within the overlap threshold, the vector semantic selection system 102 performs a pre-order traversal of the existing groupings of vector paths to perform an act 610 of determining if a child group exists.

In one or more embodiments, a pre-order traversal refers to a method of traversing a hierarchical structure (e.g., a tree traversal). In particular, the vector semantic selection system 102 performs a pre-order traversal by starting at the root of the vector graphic, such as a top-level grouping or layer in the digital design document. Further, the vector semantic selection system 102 processes the root of the vector graphic by calculating the intersection over union for the top-level group and if the overlap threshold is not satisfied, then traversing to a left subtree, and finally a right subtree. In other words, the vector semantic selection system traverses the vector graphic until an intersection over union is found that satisfies the overlap threshold.

Furthermore, as shown, if a child group does not exist, the vector semantic selection system 102 further performs an act 612 of determining whether a sibling group exists. As shown in FIG. 6A, if a child group/sibling group exists, the vector semantic selection system 102 repeats the process of determining whether the child group/sibling group lies in the mask within the overlap threshold.

To illustrate, the vector semantic selection system 102 iterates from a parent group (e.g., the human object grouping) to a child group (e.g., an upper body group) or a sibling group (e.g., the upper body grouping and the lower body grouping would be sibling groups to each other). Furthermore, FIG. 6A shows that when none of the existing groupings of vector paths lie in the mask within an overlap threshold, the vector semantic selection system 102 performs an act 614 of updating all paths to user visible paths.

FIG. 6B shows additional details of the vector semantic selection system 102 iterating through existing groupings of vector paths to identify a set of vector paths that satisfy an overlap threshold. In one or more embodiments, the vector semantic selection system 102 compiles all vector paths into a list for each group (e.g., the vector semantic selection system 102 has a list of vector paths for each group). FIG. 6B shows the vector semantic selection system 102 receiving a selection 616 of a semantic mask.

As shown in FIG. 6B, in response to the selection 616, the vector semantic selection system 102 performs an act 618 of obtaining a top-level grouping based on the semantic mask of a semantic region. In other words, if user input indicated a point on a face of a human object and the vector semantic selection system 102 generates a semantic mask for the semantic region of face, the vector semantic selection system 102 further obtains a top-level group such as the entire head of the human object or just the face of the human object.

Moreover, FIG. 6B shows that in some embodiments, the vector semantic selection system 102 performs an act 620 of converting the grouping (e.g., the top-level grouping) to polylines. Further, FIG. 6B also shows that in some embodiments, the vector semantic selection system 102 performs an act 622 of calculating polylines of the semantic mask (e.g., using a Ramer-Douglas-Peucker (RDP) algorithm discussed in more detail below).

In one or more embodiments, the vector semantic selection system 102 generates a set of polylines. In particular, a polyline refers to a series of straight-line segments connected by points, which are used to approximate curves in vector graphics. For example, a polyline refers to a continuous line made up of connected straight line segments where each straight-line segment is defined by two endpoints and the polyline is formed by sequentially connecting these endpoints. In some embodiments, a polyline is open (e.g., no closure between the first and last points) or closed (e.g., closure between the first and last point).

In one or more embodiments, the vector semantic selection system 102 generates a set of group polylines for the obtained grouping (e.g., the top-level group of vector paths) and further generates a set of mask polylines from the semantic mask. As shown in FIG. 6B, the vector semantic selection system 102 performs an act 624 of determining an intersection over union between the set of group polylines (e.g., for the top-level group) and the set of mask polylines.

In one or more embodiments, an intersection over union refers to a measure of overlap between two areas. For example, the vector semantic selection system 102 determines the intersection over union as,

$$IoU = \frac{Area of Intersection}{Area of Union}$$

In particular, the vector semantic selection system 102 determines the intersection over union by taking an area of intersection divided by an area of union. In some embodiments, an area of intersection refers to an area that is common to both the union of the set of group polylines and the set of mask polylines. In some embodiments, the area of union (e.g., the total area covered) is the area that is covered by either the union of the set of group polylines or the set of mask polylines, or both. To illustrate, the vector semantic selection system generates an intersection over union that ranges from 0-1, where 1 indicates that the regions (e.g., the group and the mask) completely overlap and 0 indicates that there is no overlap.

Furthermore, as shown in FIG. 6B, the vector semantic selection system 102 performs an act 626 of determining whether the intersection over union satisfies an overlap threshold. In some embodiments, the vector semantic selection system 102 establishes an overlap threshold. As mentioned above, the vector semantic selection system 102 generates an intersection over union between 0-1 and further determines whether the intersection over union satisfies an overlap threshold (e.g., 0.9 or 90%).

As shown in FIG. 6B, if the intersection over union satisfies an overlap threshold, the vector semantic selection system 102 performs an act 628 of selecting the grouping (e.g., selecting a set of vector paths of the grouping). Moreover, as shown in FIG. 6B, if the intersection over union does not satisfy an overlap threshold, the vector semantic selection system 102 further performs an act 630 of obtaining a child grouping or performs an act 632 of obtaining a sibling grouping of vector paths. As shown, for the child grouping or the sibling grouping, the vector semantic selection system 102 converts the grouping to polylines (e.g., a set of group polylines) utilizing the methods discussed above.

In other words, FIG. 6B illustrates how the vector semantic selection system 102 ensures that the most optimal grouping of vector paths is identified. In particular, the vector semantic selection system 102 identifies the most optimal grouping of vector paths by traversing a vector graphic starting from a parent grouping and then checking nested groupings of vector paths. For example, the vector semantic selection system 102 starts with a parent group (which in some instances covers a large area in the vector graphic) and then moves on to a nested group which covers a more specific area that more optimally matches the semantic mask (e.g., within an overlap threshold).

As mentioned above, in some embodiments, the vector semantic selection system 102 identifies visible vector paths in the vector graphic to return as a selection of a semantic region. FIG. 7A shows the vector semantic selection system 102 identifying visible vector paths that satisfy an overlap threshold with a semantic mask. As shown in FIG. 7A, in response to the vector semantic selection system 102 determining that none of the existing groupings of vector paths satisfy an overlap threshold, the vector semantic selection system 102 performs an act 702 of updating all paths in a vector graphic to user visible paths. In particular, FIG. 7A shows the vector semantic selection system 102 performing an act 704 of determining whether a path lies in a mask (e.g., within an overlap threshold).

As shown, if the path does lie in the mask within an overlap threshold, the vector semantic selection system 102 performs an act 706 of selecting the path. Moreover, as also shown, if the path does not lie in the mask within an overlap threshold, the vector semantic selection system 102 performs an act 708 of iterating to another visible path (e.g., if it exists) and performing the act 704. As shown, once the vector semantic selection system 102 identifies one or more visible paths that lie in the mask within an overlap threshold, the vector semantic selection system 102 performs an act 710 of exiting (e.g., selecting the one or more visible paths that satisfy the overlap threshold).

FIG. 7B provides additional details of the vector semantic selection system 102 selecting visible paths. As shown in FIG. 7B, the vector semantic selection system 102 performs an act 712 of determining a pre-order traversal in a vector graphic.

In some embodiments, the vector semantic selection system 102 further performs a pre-order traversal to select vector paths based on user visible paths. In particular, the vector semantic selection system 102 constructs a list of paths in the vector graphic by using the pre-order traversal that defines a painting order of the vector graphic (e.g., start with a top-level group and render the elements in the vector graphic where the parent elements are processed before the nested elements). In other words, vector paths that appear earlier in a painting order appear on top of paths that come later in the painting order.

Furthermore, the vector semantic selection system 102 uses a polyline model to perform an act 714 of converting/generating polylines for a list of paths in the vector graphic (e.g., according to the pre-order traversal that defines a painting order). Moreover, the vector semantic selection system 102 performs an act 716 of updating the set of polylines to only include visible paths as indicated by the pre-order traversal. In other words, the vector semantic selection system 102 updates the polylines to include polylines that are in the foreground and not obstructed or hidden behind other polylines.

As shown, the vector semantic selection system 102 performs an act 718 of calculating polylines of the semantic mask (e.g., a set of mask polylines) using an RDP algorithm 719. In one or more embodiments, the RDP algorithm 719 refers to a line simplification algorithm to reduce the number of points in a curve or polyline while retaining the overall shape and structure. In particular, the vector semantic selection system 102 utilizes the RDP algorithm 719 to remove points from a polyline that are not necessary for approximating an original curve with a specified level of accuracy.

In other words, the vector semantic selection system utilizes the RDP algorithm to simplify a representation (e.g., a semantic mask). In one or more embodiments, the vector semantic selection system 102 utilizes the RDP algorithm 719 of the polyline model which enhances performance of selecting specific elements of a vector graphic without compromising accuracy (e.g., particularly on CPU-only devices).

To illustrate, the vector semantic selection system 102 utilizes the RDP algorithm of a polyline model to extract mask contours of the semantic mask. In one or more embodiments, mask contours refer to outlines or boundaries of the semantic mask. In particular, the mask contours refer to curves that join continuous points along a boundary of the semantic mask (e.g., the contours mark the outline of an object that the semantic mask encompasses).

In one or more embodiments, the vector semantic selection system 102 generates the set of mask polyline for the semantic mask from Bezier curve approximations of the semantic mask and mask contours extracted by the RDP algorithm of the polyline model. In one or more embodiments, a Bezier curve refers to a set of control points that allows for a smooth, flexible creation of curves in a variety of shapes and forms. In particular, a vector path is a broader concept that includes all types of connected lines and curves (e.g., straight lines, and Bezier curves).

As shown in FIG. 7B, the vector semantic selection system 102 performs an act 720 of determining an intersection over union. In particular, the vector semantic selection system 102 determines the intersection over union of the set of visible vector path polylines and further identifies one or more polylines of the set of visible vector path polylines that satisfy an additional overlap threshold with the set of mask polylines. As shown in FIG. 7B, the vector semantic selection system 102 performs an act 722 of selecting paths that satisfy the additional overlap threshold. In some embodiments, the additional overlap threshold is the same as the overlap threshold discussed in FIGS. 6A-6B. In some embodiments, the additional overlap threshold is different than the overlap threshold discussed in FIGS. 6A-6B. To illustrate, in some embodiments, the overlap threshold described in FIGS. 6A-6B is 90% while the additional overlap threshold discussed in FIGS. 7A-7B is 70%.

The tables below illustrate algorithms for obtaining polylines from the vector graphic and updating the polylines to include visible path polylines.

Algorithm 1 Get Polylines from Art

| | |
|---|---|
| 1: | function GetPolylinesFromVectorArt |
| 2: | outPolylines ← empty list |
| 3: | type ← kUnknownArt |
| 4: | GetArtType(handle, type) |
| 5: | if type = kCompoundPathArt v type = kGroupArt then |
| 6: | child ← null |
| 7: | GetArtFirstChild (handle, child) |
| 8: | while child is not null do |
| 9: | childPolylines ← GetPolyLinesFromVectorArt (child, lengthTolerance) |
| 10: | AppendchildPolylines to outPolylines |
| 11: | GetArtSibling(child, child) |
| 12: | end while |
| 13: | else if type = kPathArt then |
| 14: | pathPolyline ← BezierToPolyline(handle) |
| 15: | AppendpathPolyline to outPolylines |
| 16: | end ifreturn outPolylines |
| 17: | end function |

As discussed above in FIGS. 6A-7B, Algorithm 1 describes obtaining polylines from a vector graphic. In particular, Algorithm 1 describes starting with an empty list of polylines and obtaining the handles and types of the vector paths in the vector graphic. Moreover, Algorithm 1 describes populating the list with each grouping within the vector graphic (e.g., starting with a top-level group and traversing a tree structure). Further, Algorithm 1 describes obtaining polylines for each group that is not empty.

Algorithm 2 UpdateVisiblePathsPolyLine

| | |
|---|---|
| 1: | function UpdateVisiblePathsPolyline (paths2PolylinesMap, pathsInPreOrder) |
| 2: | union Polyline ← empty Paths64 |
| 3: | for i= 0 ← to pathsInPreOrder.size( ) - 1 do |
| 4: | currentPath ← pathsInPreOrder[i] |
| 5: | currentPolyline ← paths2PolylinesMap[currentPath] |
| | Subtract the union of all previous paths from the current one |
| 6: | currentPolyline ← Clipper2Lib::Difference(currentPolyline, unionPolyline, EvenOdd) |
| 7: | paths2PolylinesMap[currentPath] ← currentPolyline |
| 8: | unionPolyline ← Clipper2Lib::Union(unionPolyline, paths2PolylinesMap[currentPath], |
| | EvenOdd) |
| 9: | end for |
| 10: | end function |

Furthermore, Algorithm 2 describes updating the list of polylines to visible path polylines. As described above in FIGS. 7A-7B, the vector semantic selection system 102 looks to visible paths when the existing groupings do not satisfy an overlap threshold. As shown above, Algorithm 2 describes obtaining current vector paths based on a pre-order traversal (described above), converting the vector paths to polylines, and subtracting the union of all previous paths from the current path (e.g., for a current polyline path). In other words, the vector semantic selection system 102 updates a list of vector paths to only include the visible paths based on the pre-order traversal (e.g., a painting order).

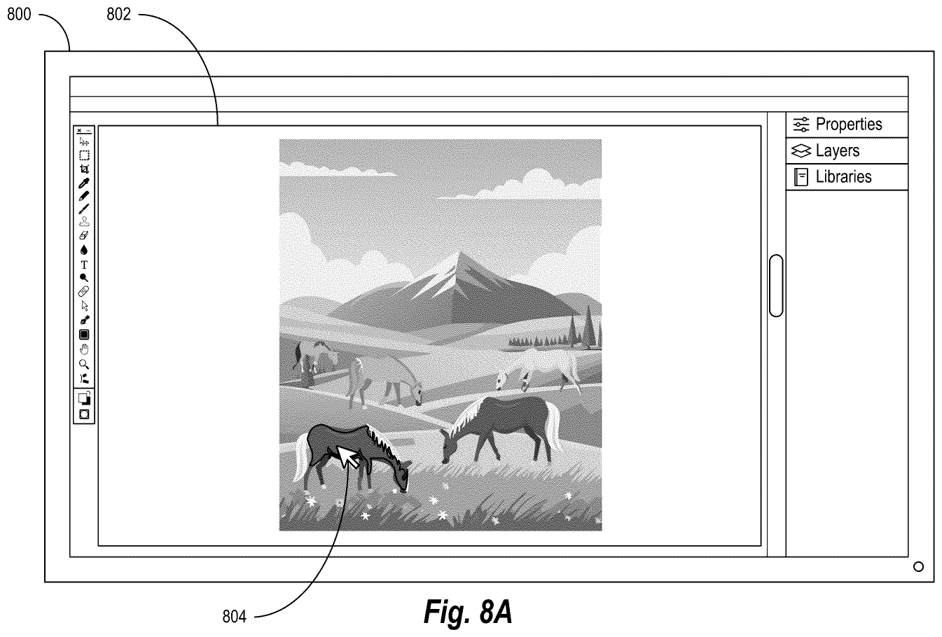

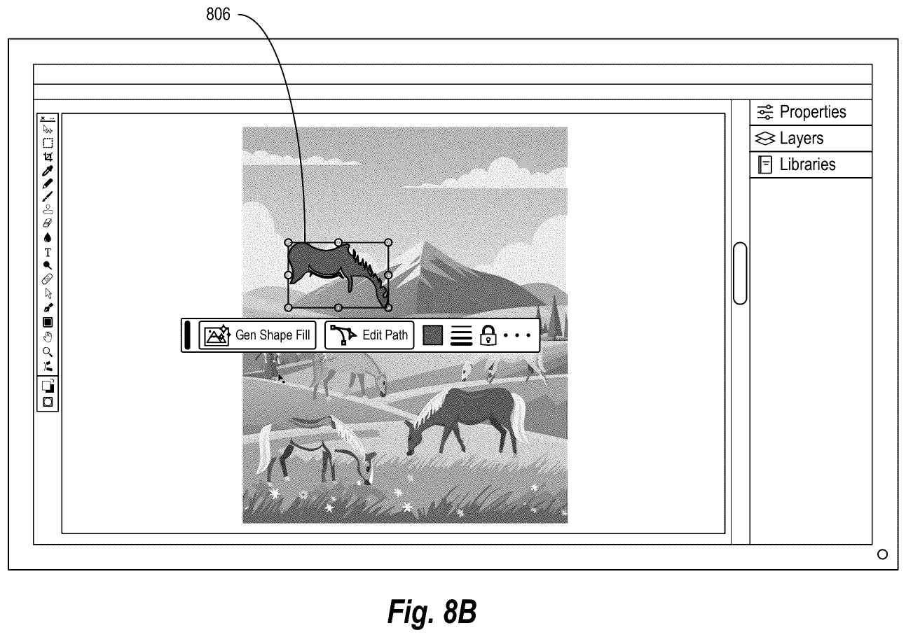

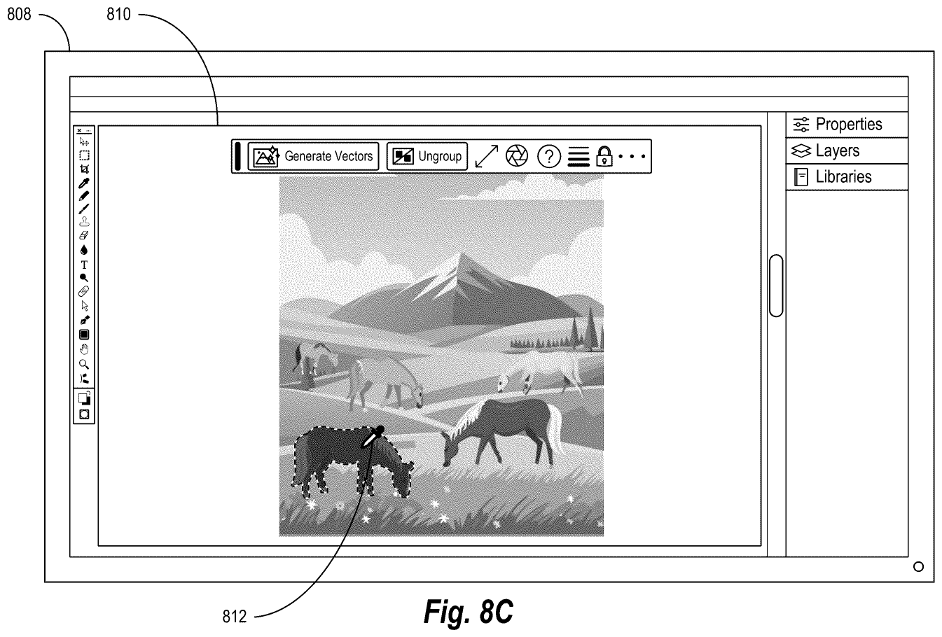

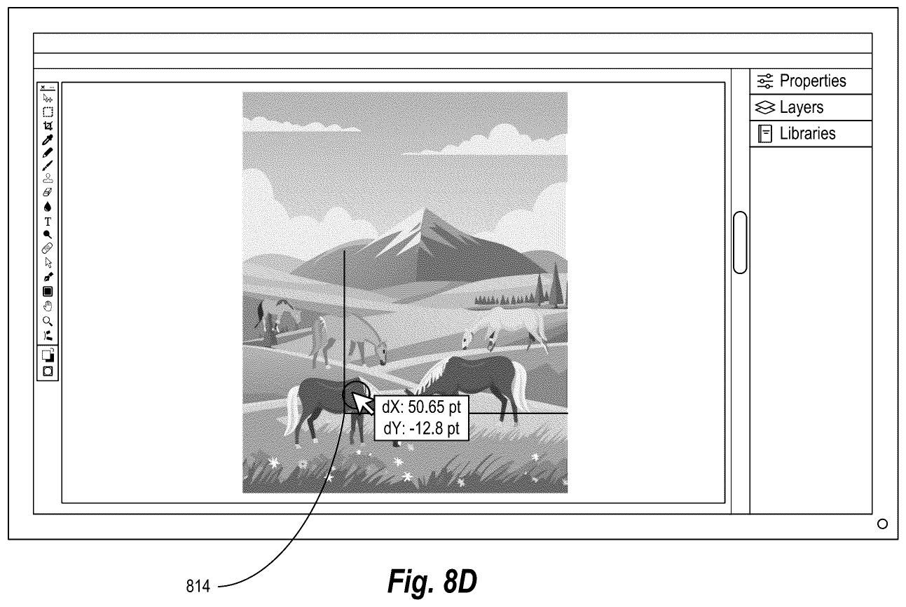

FIGS. 8A-8B illustrates inaccuracies and inefficiencies of existing systems selecting a vector object in a vector graphic. FIG. 8A shows a graphical user interface 802 of a computing device 800 and a digital design document displayed on the graphical user interface 802. In particular, the digital design document shown in FIG. 8A contains vector graphic artwork of horses grazing on grass. Moreover, FIG. 8A shows a selection 804 of the frontmost left horse. In particular, in existing systems, a selection of a specific vector object is inaccurate and inefficient due to vector paths being organized in a complex manner.

Furthermore, as also mentioned above, vector graphic objects include unintuitive groupings of elements, absence of visual indicators and complicated layer hierarchies that hinder logical object selection. As shown in FIG. 8B, a user of the computing device 800 attempts to modify the selection 804 by performing a manipulation 806. However, FIG. 8B shows that the manipulation 806 results in only a part of the frontmost left horse moving (e.g., the outline, the mane, and the tail are left behind).

In contrast, FIGS. 8C-8D illustrate the vector semantic selection system 102 accurately and efficiently selecting a vector object and manipulating the selected vector object. FIG. 8C shows a graphical user interface 810 of a computing device 808 (e.g., of the vector semantic selection system 102) that includes a digital design document displayed on the graphical user interface 810. In particular, FIG. 8C shows a selection 812 of the frontmost left horse. Even though vector objects are organized in a complex manner across layer hierarchies, FIG. 8C and FIG. 8D shows the vector semantic selection system 102 accurately selecting the entire frontmost left horse object in the digital design document and performing a manipulation 814. For instance, FIG. 8D shows a user of the computing device 808 moving the selection 812 (e.g., the entire horse) to a different position within the digital design document. Unlike existing systems, the vector semantic selection system 102 does not leave behind part of the horse object.

As described above, the vector semantic selection system 102 receives the user input (e.g., the selection 812) and leverages the semantic segmentation model to generate a semantic mask responsive to the user input. In particular, FIG. 8C shows the selection 812 as hovering over the frontmost left horse, thus the vector semantic selection system 102 generates a semantic mask encompassing the frontmost left horse.

Moreover, in response to a user of the computing device 808 confirming the selection 812, the vector semantic selection system 102 converts the vector paths of the vector graphic into polylines to determine which vector paths satisfy an overlap threshold with the semantic mask. Additionally, FIG. 8D shows that the vector semantic selection system 102 returns the selected set of vector paths to the user of the computing device 808 as a selection of a semantic region (e.g., the frontmost left horse).

In some embodiments, the vector semantic selection system 102 accounts for vector paths, compound vector paths (e.g., multiple paths combined into one object, where one path cuts out parts of another, enabling complex shapes), and group art (e.g., groupings) in the vector graphic to ensure robust selection, even when logical groupings are absent in the vector graphic. In particular, the vector semantic selection system 102 does so by converting the vector paths, compound vector paths, and group art to polylines to determine which polylines are the relevant polylines (e.g., to return as a selection of a semantic region).

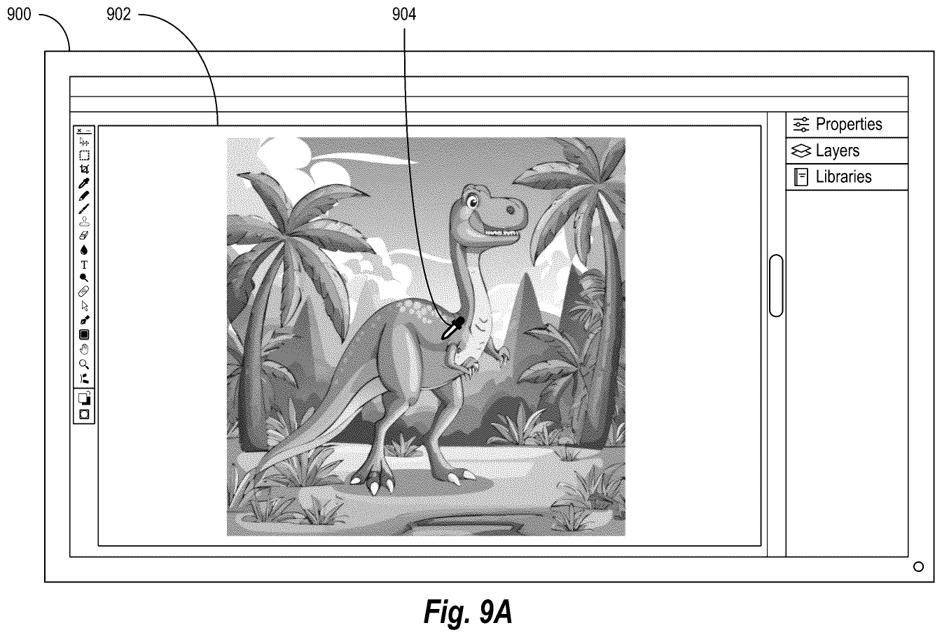

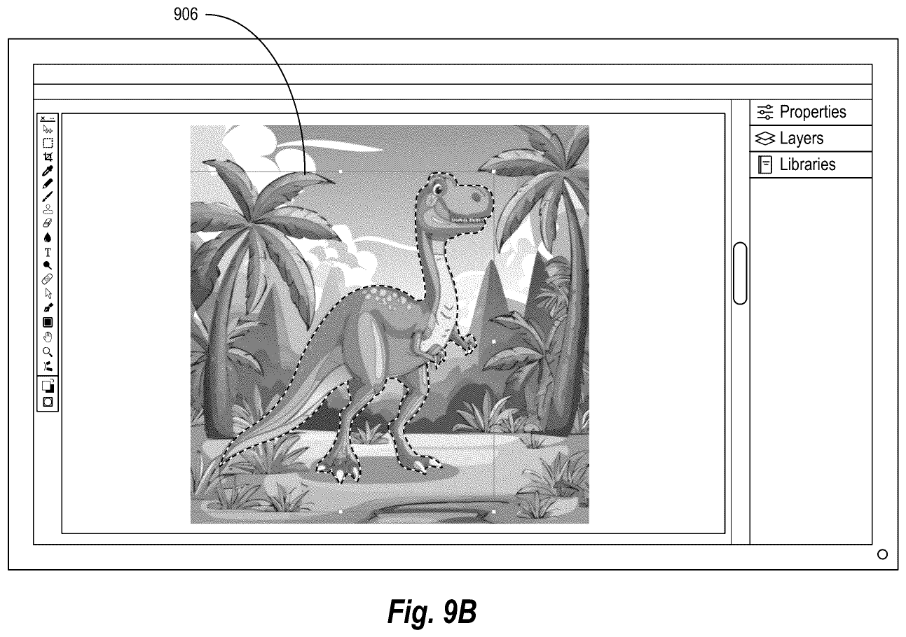

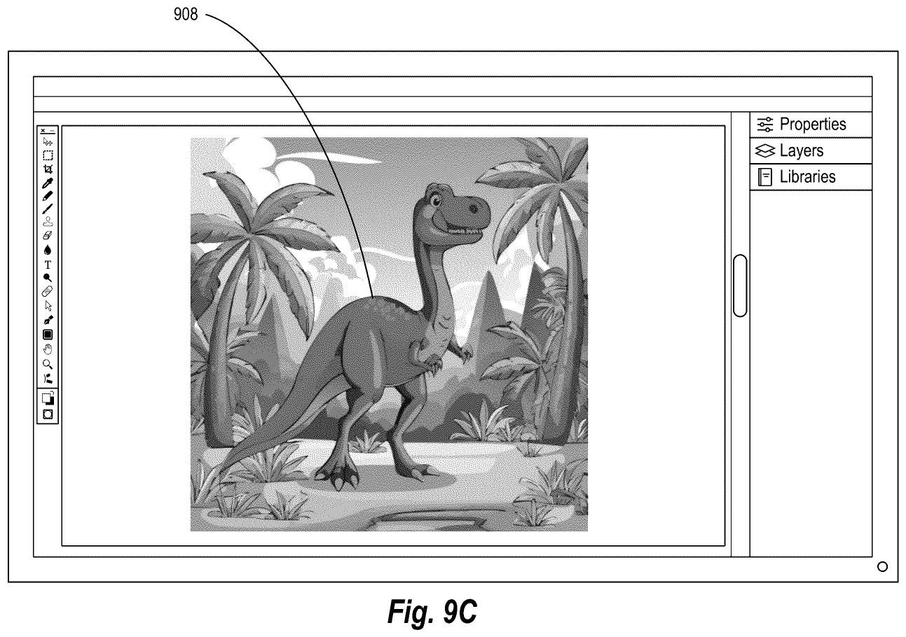

FIGS. 9A-9C illustrates the vector semantic selection system 102 selecting a vector object and applying a color change to the selected vector object in accordance with one or more embodiments. FIG. 9A shows a graphical user interface 902 of a computing device 900 and a digital design document displayed on the graphical user interface 902. In particular, FIG. 9A shows a selection 904 of a dinosaur object shown in the digital design document. For example, in response to the selection 904, the vector semantic selection system 102 generates a semantic mask for the dinosaur object (e.g., the semantic region).

Moreover, FIG. 9B shows the selection 904 results in a bounding box 906 that accurately and efficiently selects the entire dinosaur object despite the dinosaur object containing vector paths with unintuitive groupings of elements, absence of visual indicators, and complicated layer hierarchies. In particular, the vector semantic selection system 102 converts vector paths in the vector graphic to polylines to determine polylines that satisfy an overlap threshold with the semantic mask. Moreover, the vector semantic selection system 102 returns the polylines that satisfy an overlap threshold to the user of the computing device as a selection of the semantic region (e.g., the dinosaur object).

Furthermore, FIG. 9C shows the vector semantic selection system 102 receiving a manipulation 908 that modifies a color of the entire dinosaur object. In contrast to existing systems which would require numerous clicks to accurately select the entire dinosaur object, FIGS. 9A-9C show the vector semantic selection system 102 efficiently and accurately selecting the entire object with a single click and modifying the color of the dinosaur object.

Turning to FIG. 10, additional detail will now be provided regarding various components and capabilities of the vector semantic selection system 102. In particular, FIG. 10 illustrates an example schematic diagram of a computing device 1000 (e.g., the server device(s) 104 and/or the client device 112) implementing the vector semantic selection system 102 in accordance with one or more embodiments of the present disclosure for components 1000-1014. As illustrated in FIG. 10, the vector semantic selection system 102 includes a vector graphic manager 1002, a semantic mask manager 1004, a semantic segmentation model 1006, a vector path selection manager 1008, a polyline model 1010, a semantic region selection manager 1012, and a storage manager 1014.

The vector graphic manager 1002 accesses a vector graphic in a digital design document for manipulating vector artwork. For example, the vector graphic manager 1002 provides a digital design document via a digital design application to modify vector graphics. Specifically, the vector graphic manager 1002 accesses a vector graphic that includes a set of shapes that are composed of vector paths. In some embodiments, the vector graphic manager 1002 accesses the vector graphic with groupings of vector paths, where the groupings contain multiple types of shapes/objects and the shapes/objects in the same grouping are manipulated as a single unit. Moreover, the vector graphic manager 1002 provides various tools for modifying or applying changes to specific elements within a vector graphic.

The semantic mask manager 1004 monitors a digital design application for user input. Specifically, the semantic mask manager 1004 monitors the digital design application for input such as indicating a portion in the vector graphic. For example, the user input includes hovering over a specific portion of a vector graphic, using a lasso tool, or using a marquee tool. Furthermore, in response to user input indicating a portion of the vector graphic, the semantic mask manager 1004 generates a semantic mask. In particular, the semantic mask manager 1004 generates the semantic mask using the semantic segmentation model 1006. For example, the semantic mask manager 1004 uses the semantic segmentation model 1006 to process a raster version of the vector graphic along with the user input to generate the semantic mask.

The vector path selection manager 1008 selects relevant vector paths in a vector graphic for a user of a computing device. Specifically, the vector path selection manager 1008 works with the semantic mask manager 1004 to determine a region of interest. In some embodiments, the semantic mask manager 1004 passes a semantic mask to the vector path selection manager 1008 and the vector path selection manager 1008 uses the polyline model 1010 to convert vector paths to polyline. Moreover, the vector path selection manager 1008 converts the semantic mask to polylines using the polyline model 1010. In addition, the vector path selection manager 1008 selects a set of vector paths that correspond to a location of the semantic mask, based on the set of vector paths satisfying an established overlap threshold.

The semantic region selection manager 1012 provides a selected set of vector paths to a user of a computing device. Specifically, the semantic region selection manager 1012 provides a set of vector paths as a selection of a semantic region. In other words, the semantic region selection manager 1012 provides the set of vector paths as a single unit for manipulation to a user of a computing device based on the user input.

The storage manager 1014 stores various components discussed in FIG. 10. For example, the storage manager 1014 stores vector graphics, vector paths, user input, the semantic segmentation model 1005, semantic masks, the polyline model 1010, polylines, and selected vector paths. Additionally, the storage manager 1014 also stores training components such as a vector data to fine-tune/optimize parameters of the semantic segmentation model 1005.

Each of the components 1000-1014 of the vector semantic selection system 102 include software, hardware, or both. For example, the components 1000-1014 include one or more instructions stored on a computer-readable storage medium and executable by processors of one or more computing devices, such as a client device or server device. When executed by the one or more processors, the computer-executable instructions of the vector semantic selection system 102 cause the computing device(s) to perform the methods described herein. Alternatively, the components 1000-1014 include hardware, such as a special-purpose processing device to perform a certain function or group of functions. Alternatively, the components 1000-1014 of the vector semantic selection system 102 include a combination of computer-executable instructions and hardware.

Furthermore, the components 1000-1014 of the vector semantic selection system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1000-1014 of the vector semantic selection system 102 may be implemented as a stand-alone application, such as a desktop or mobile application. Furthermore, the components 1000-1014 of the vector semantic selection system 102 may be implemented as one or more web-based applications hosted on a remote server. Alternatively, or additionally, the components 1000-1014 of the vector semantic selection system 102 may be implemented in a suite of mobile device applications or “apps.” For example, in one or more embodiments, the vector semantic selection system 102 comprise or operate in connection with digital software applications such as ADOBE® ILLUSTRATOR, ADOBE® EXPRESS, ADOBE® INDESIGN CC, and ADOBE® ANIMATE.

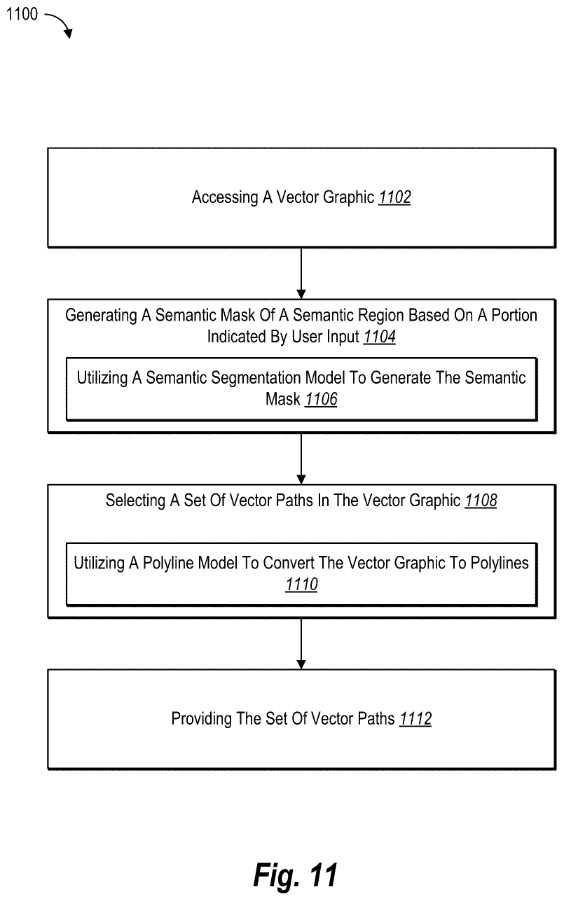

FIGS. 1-11, the corresponding text, and the examples provide a number of different methods, systems, devices, and non-transitory computer-readable media of the components 1002-1014. In addition to the foregoing, one or more embodiments are described in terms of flowcharts comprising acts for accomplishing the particular result. For example, FIG. 11 illustrates a flowchart of example sequences of acts in accordance with one or more embodiments.

FIG. 11 illustrates a flowchart of a series of acts 1100 for selecting a set of vector paths in a vector graphic in accordance with one or more embodiments. FIG. 11 illustrates acts according to one embodiment, alternative embodiments may omit, add to, reorder, and/or modify any of the acts shown in FIG. 11. In some implementations, the acts of FIG. 11 are performed as part of a method. For example, in some embodiments, the acts of FIG. 11 are performed as part of a computer-implemented method. Alternatively, a non-transitory computer-readable medium stores instructions thereon that, when executed by at least one processor, cause a computing device to perform the acts of FIG. 11. In some embodiments, a system performs the acts of FIG. 11. For example, in one or more embodiments, a system includes at least one memory device. The system further includes at least one server device configured to cause the system to perform the acts of FIG. 11.

The series of acts 1100 includes an act 1102 of accessing a vector graphic. Further, the series of acts 1100 includes an act 1104 of generating a semantic mask of a semantic region based on a portion indicated by user input and a sub-act 1106 of utilizing a semantic segmentation model to generate the semantic mask. Moreover, the series of acts 1100 includes an act 1108 of selecting a set of vector paths in the vector graphic and a sub-act 1110 of utilizing a polyline model to convert the vector graphic to polyline. Further, the series of acts 1100 includes an act 1112 of providing the set of vector paths.

In particular, the act 1102 includes accessing a vector graphic comprising a set of shapes. Further, the act 1104 includes in response to user input indicating a portion of the vector graphic, generating, utilizing a semantic segmentation model, a semantic mask of a semantic region based on the portion indicated by the user input. Moreover, the act 1108 includes selecting, utilizing a polyline model, a set of vector paths in the vector graphic corresponding to a location of the semantic mask. Further, the act 1112 providing the set of vector paths as a selection of the semantic region.

For example, in one or more embodiments, the series of acts 1100 includes generating, utilizing the polyline model, a set of mask polylines from the semantic mask. In addition, in one or more embodiments, the series of acts 1100 includes generating, utilizing the polyline model, a set of group polylines from a grouping of vector paths in the vector graphic. Further, in one or more embodiments, the series of acts 1100 includes determining an intersection over union between the set of mask polylines and the set of group polylines. Further, in some embodiments, the series of acts 1100 includes based on the intersection over union satisfying an overlap threshold, selecting the grouping of vector paths as the set of vector paths to return as the selection of the semantic region.

Moreover, in one or more embodiments, the series of acts 1100 includes based on an intersection over union between the set of mask polylines and the set of group polylines failing to satisfy an overlap threshold, generating a set of nested polylines for a nested grouping of vector paths within the grouping of vector paths. Further, in one or more embodiments, the series of acts 1100 includes determining an additional intersection over union between the set of mask polylines and the set of nested polylines. Moreover, in one or more embodiments, the series of acts 1100 includes based on the additional intersection over union satisfying the overlap threshold, selecting the nested grouping of vector paths as the set of vector paths to return as the selection of the semantic region. Further, in one or more embodiments, the series of acts 1100 includes based on an intersection over union between the set of mask polylines and the set of group polylines failing to satisfy an overlap threshold, identifying visible vector paths in the vector graphic by using a pre-order traversal of the vector graphic that defines a painting order of the vector graphic. Moreover, in one or more embodiments, the series of acts 1100 includes generating a set of visible vector path polylines from the visible vector paths in the vector graphic.

Additionally, in one or more embodiments, the series of acts 1100 includes determining an additional intersection over union between the set of mask polylines and the set of visible vector path polylines. In one or more embodiments, the series of acts 1100 includes selecting visible vector paths associated with the set of visible vector path polylines that satisfy a visible vector path overlap threshold as the set of vector paths to return as the selection of the semantic region.

Moreover, in one or more embodiments, series of acts 1100 generating a rasterized version of the vector graphic. For example, in one or more embodiments, the series of acts 1100 includes generating, utilizing the semantic segmentation model, the semantic mask from the user input indicating the portion of the vector graphic and the rasterized version of the vector graphic.

In addition, in one or more embodiments, the series of acts 1100 includes generating a prediction score for the semantic mask. Further, in one or more embodiments, the series of acts 1100 includes generating a first additional semantic mask, a first additional prediction score, a second additional semantic mask, and a second additional prediction score based on the user input indicating the portion in the vector graphic. Further, in some embodiments, the series of acts 1100 includes based on the prediction score being greater than the first additional prediction score and the second additional prediction score, selecting the semantic mask. Moreover, in some embodiments, the series of acts 1100 includes accessing the set of shapes arranged in different layers of a digital design document, wherein the set of shapes are vector objects. In one or more embodiments, the series of acts 1100 includes accessing one or more groupings in the vector graphic, wherein the one or more groupings comprises one or more vector objects categorized as a single unit.

Furthermore, in one or more embodiments, the series of acts 1100 includes in response to user input indicating a point of a vector graphic, generating, utilizing a semantic segmentation model, a semantic mask that defines a semantic region in the vector graphic. Moreover, in one or more embodiments, the series of acts 1100 includes generating, utilizing a polyline model, a set of mask polylines from the semantic mask and a set of group polylines from a grouping of vector objects. Moreover, in one or more embodiments, the series of acts 1100 includes based on the set of mask polylines and the set of group polylines, selecting a set of vector paths in the vector graphic that satisfies an overlap threshold with the semantic mask that defines the semantic region in the vector graphic. Further, in one or more embodiments, the series of acts 1100 includes provide the set of vector paths as a selection of the semantic region.

In one or more embodiments, the series of acts 1100 includes determining an intersection over union between the set of mask polylines and the set of group polylines. Moreover, in one or more embodiments, the series of acts 1100 includes based on the intersection over union failing to satisfy an overlap threshold, generating a set of nested polylines for a nested grouping of vector paths within the grouping of vector objects. Further, in one or more embodiments, the series of acts 1100 includes determining a first additional intersection over union between the set of mask polylines and the set of nested polylines for the nested grouping of vector paths.

Moreover, in some embodiments, the series of acts 1100 includes based on the first additional intersection over union failing to satisfy the overlap threshold, generating an additional set of nested polylines for an additional nested grouping of vector paths within the grouping of vector objects. Further, in some embodiments, the series of acts 1100 includes determining a second additional intersection over union between the set of mask polylines and the additional set of nested polylines. Moreover, in some embodiments, the series of acts 1100 includes based on the second additional intersection over union satisfying the overlap threshold, selecting the additional nested grouping of vector paths to return as the selection of the semantic region.

Furthermore, in one or more embodiments, the series of acts 1100 includes receiving a refinement selection of the semantic mask as user input, wherein the refinement selection comprises an expanded semantic region relative to the semantic region. Moreover, in one or more embodiments, the series of acts 1100 includes generating an updated semantic mask based on the refinement selection. Further, in one or more embodiments, the series of acts 1100 includes from the updated semantic mask, providing an additional set of vector paths as a selection of the expanded semantic region.

In one or more embodiments, the series of acts 1100 includes accessing a set of shapes arranged in different layers of a digital design document, wherein the set of shapes are vector objects of the grouping of vector objects. In addition, in one or more embodiments, the series of acts 1100 includes accessing one or more groupings in the vector graphic, wherein the one or more groupings comprises one or more vector objects categorized as a single unit and the one or more groupings further comprises one or more nested groupings.

Further, in one or more embodiments, the series of acts 1100 includes in response to user input indicating a point of a vector graphic comprising one or more groups of vector objects, generating, utilizing a semantic segmentation model, a semantic mask that defines a semantic region in the vector graphic. Further, in some embodiments, the series of acts 1100 includes generating, utilizing a polyline model, a set of mask polylines from the semantic mask and a set of visible vector path polylines from visible vector paths of the vector graphic.

Furthermore, in one or more embodiments, the series of acts 1100 includes based on the set of mask polylines and the set of visible vector path polylines, selecting visible vector paths associated with the set of visible vector path polylines that satisfy a visible vector path overlap threshold. Moreover, in one or more embodiments, the series of acts 1100 includes providing the visible vector paths as a selection of the semantic region in the vector graphic.

Further, in one or more embodiments, the series of acts 1100 includes constructing a list of vector paths in the vector graphic by using a pre-order traversal of the vector graphic that defines a painting order of the vector graphic, wherein vector paths earlier in the painting order appear on top of vector paths that come later in the painting order. Further, in some embodiments, the series of acts 1100 includes generating, utilizing the polyline model, the set of visible vector path polylines from the list of vector paths in the vector graphic.

Furthermore, in one or more embodiments, the series of acts 1100 includes updating the set of visible vector path polylines to only include the visible vector paths as indicated by the pre-order traversal of the vector graphic. Furthermore, in one or more embodiments, the series of acts 1100 includes determining an intersection over union between the set of mask polylines and polylines of the visible vector paths. Moreover, in one or more embodiments, the series of acts 1100 includes selecting the visible vector paths associated with the set of visible vector path polylines based on the intersection over union between the set of mask polylines and the polylines of the visible vector paths satisfying the visible vector path overlap threshold.

In one or more embodiments, the series of acts 1100 includes accessing Bezier curve approximations of the semantic mask. Moreover, in one or more embodiments, the series of acts 1100 includes utilizing an RDP algorithm of the polyline model to extract mask contours of the semantic mask. In one or more embodiments, the series of acts 1100 includes generating the set of mask polylines from the Bezier curve approximations of the semantic mask and the mask contours of the semantic mask.

In one or more embodiments, the series of acts 1100 includes receiving a refinement selection of the semantic mask as user input, wherein the refinement selection comprises a reduced semantic region relative to the semantic region. Moreover, in one or more embodiments, the series of acts 1100 includes generating an updated semantic mask based on the refinement selection. In one or more embodiments, the series of acts 1100 includes from the updated semantic mask, providing additional visible vector paths as the selection of the reduced semantic region.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., the server device(s) 104 and/or the client device 112). In one or more embodiments, the computing device 1200 may be a mobile device (e.g., a mobile telephone, a smartphone, a PDA, a tablet, a laptop, a camera, a tracker, a watch, a wearable device). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 include hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 including storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
accessing a vector graphic comprising a set of shapes;
in response to user input indicating a portion of the vector graphic, generating, utilizing a semantic segmentation model, a semantic mask of a semantic region based on the portion indicated by the user input;
selecting, utilizing a polyline model, a set of vector paths in the vector graphic corresponding to a location of the semantic mask; and
providing the set of vector paths as a selection of the semantic region.

2. The computer-implemented method of claim 1, wherein utilizing the polyline model comprises:
generating, utilizing the polyline model, a set of mask polylines from the semantic mask; and
generating, utilizing the polyline model, a set of group polylines from a grouping of vector paths in the vector graphic.

3. The computer-implemented method of claim 2, wherein selecting the set of vector paths in the vector graphic comprises:
determining an intersection over union between the set of mask polylines and the set of group polylines; and
based on the intersection over union satisfying an overlap threshold, selecting the grouping of vector paths as the set of vector paths to return as the selection of the semantic region.

4. The computer-implemented method of claim 2, wherein selecting the set of vector paths in the vector graphic comprises:
based on an intersection over union between the set of mask polylines and the set of group polylines failing to satisfy an overlap threshold, generating a set of nested polylines for a nested grouping of vector paths within the grouping of vector paths;
determining an additional intersection over union between the set of mask polylines and the set of nested polylines; and
based on the additional intersection over union satisfying the overlap threshold, selecting the nested grouping of vector paths as the set of vector paths to return as the selection of the semantic region.

5. The computer-implemented method of claim 2, wherein selecting the set of vector paths in the vector graphic comprises:
based on an intersection over union between the set of mask polylines and the set of group polylines failing to satisfy an overlap threshold, identifying visible vector paths in the vector graphic by using a pre-order traversal of the vector graphic that defines a painting order of the vector graphic; and
generating a set of visible vector path polylines from the visible vector paths in the vector graphic.

6. The computer-implemented method of claim 5, further comprising:
determining an additional intersection over union between the set of mask polylines and the set of visible vector path polylines; and
selecting visible vector paths associated with the set of visible vector path polylines that satisfy a visible vector path overlap threshold as the set of vector paths to return as the selection of the semantic region.

7. The computer-implemented method of claim 1, wherein generating the semantic mask comprises:
generating a rasterized version of the vector graphic; and
generating, utilizing the semantic segmentation model, the semantic mask from the user input indicating the portion of the vector graphic and the rasterized version of the vector graphic.

8. The computer-implemented method of claim 1, further comprising:
generating a prediction score for the semantic mask;
generating a first additional semantic mask, a first additional prediction score, a second additional semantic mask, and a second additional prediction score based on the user input indicating the portion in the vector graphic; and
based on the prediction score being greater than the first additional prediction score and the second additional prediction score, selecting the semantic mask.

9. The computer-implemented method of claim 1, wherein accessing the vector graphic comprises:
accessing the set of shapes arranged in different layers of a digital design document, wherein the set of shapes are vector objects; and
accessing one or more groupings in the vector graphic, wherein the one or more groupings comprises one or more vector objects categorized as a single unit.

10. A system comprising:
one or more memory devices; and
one or more processors coupled to the one or more memory devices, configured to cause the system to:
in response to user input indicating a point of a vector graphic, generate, utilizing a semantic segmentation model, a semantic mask that defines a semantic region in the vector graphic;
generate, utilizing a polyline model, a set of mask polylines from the semantic mask and a set of group polylines from a grouping of vector objects;
based on the set of mask polylines and the set of group polylines, select a set of vector paths in the vector graphic that satisfies an overlap threshold with the semantic mask that defines the semantic region in the vector graphic; and
provide the set of vector paths as a selection of the semantic region.

11. The system of claim 10, wherein the one or more processors are configured to cause the system to select the set of vector paths in the vector graphic by:
determining an intersection over union between the set of mask polylines and the set of group polylines;
based on the intersection over union failing to satisfy an overlap threshold, generating a set of nested polylines for a nested grouping of vector paths within the grouping of vector objects; and
determining a first additional intersection over union between the set of mask polylines and the set of nested polylines for the nested grouping of vector paths.

12. The system of claim 11, wherein the one or more processors are configured to cause the system to select the set of vector paths in the vector graphic by:
based on the first additional intersection over union failing to satisfy the overlap threshold, generating an additional set of nested polylines for an additional nested grouping of vector paths within the grouping of vector objects;
determining a second additional intersection over union between the set of mask polylines and the additional set of nested polylines; and
based on the second additional intersection over union satisfying the overlap threshold, selecting the additional nested grouping of vector paths to return as the selection of the semantic region.

13. The system of claim 12, wherein the one or more processors are configured to cause the system to:
receive a refinement selection of the semantic mask as user input, wherein the refinement selection comprises an expanded semantic region relative to the semantic region;
generate an updated semantic mask based on the refinement selection; and
from the updated semantic mask, provide an additional set of vector paths as a selection of the expanded semantic region.

14. The system of claim 10, wherein the one or more processors are configured to cause the system to access the vector graphic by:
accessing a set of shapes arranged in different layers of a digital design document, wherein the set of shapes are vector objects of the grouping of vector objects; and
accessing one or more groupings in the vector graphic, wherein the one or more groupings comprises one or more vector objects categorized as a single unit and the one or more groupings further comprises one or more nested groupings.

15. A non-transitory computer-readable medium storing executable instructions which, when executed by at least one processing device, cause the at least one processing device to perform operations comprising:
in response to user input indicating a point of a vector graphic comprising one or more groups of vector objects, generating, utilizing a semantic segmentation model, a semantic mask that defines a semantic region in the vector graphic;
generating, utilizing a polyline model, a set of mask polylines from the semantic mask and a set of visible vector path polylines from visible vector paths of the vector graphic;
based on the set of mask polylines and the set of visible vector path polylines, selecting visible vector paths associated with the set of visible vector path polylines that satisfy a visible vector path overlap threshold; and
providing the visible vector paths as a selection of the semantic region in the vector graphic.

16. The non-transitory computer-readable medium of claim 15, wherein generating the set of visible vector path polylines comprises:
constructing a list of vector paths in the vector graphic by using a pre-order traversal of the vector graphic that defines a painting order of the vector graphic, wherein vector paths earlier in the painting order appear on top of vector paths that come later in the painting order; and
generating, utilizing the polyline model, the set of visible vector path polylines from the list of vector paths in the vector graphic.

17. The non-transitory computer-readable medium of claim 16, further comprising:
updating the set of visible vector path polylines to only include the visible vector paths as indicated by the pre-order traversal of the vector graphic; and
determining an intersection over union between the set of mask polylines and polylines of the visible vector paths.

18. The non-transitory computer-readable medium of claim 17, further comprising selecting the visible vector paths associated with the set of visible vector path polylines based on the intersection over union between the set of mask polylines and the polylines of the visible vector paths satisfying the visible vector path overlap threshold.

19. The non-transitory computer-readable medium of claim 15, wherein generating the set of mask polylines comprises:
accessing Bezier curve approximations of the semantic mask;
extracting mask contours of the semantic mask; and
generating the set of mask polylines from the Bezier curve approximations of the semantic mask and the mask contours of the semantic mask.

20. The non-transitory computer-readable medium of claim 15, wherein the operations further comprise:
receiving a refinement selection of the semantic mask as user input, wherein the refinement selection comprises a reduced semantic region relative to the semantic region;
generating an updated semantic mask based on the refinement selection; and
from the updated semantic mask, providing additional visible vector paths as the selection of the reduced semantic region.
